(19) United States
(12) Patent Application Publication
(10) Pub. No.: US 2019/0109919 A1
(43) Pub. Date: Apr. 11, 2019

(54) SENSORS AND SYSTEMS FOR IOT AND IFTTT APPLICATIONS AND RELATED METHODS

(71) Applicant: Hoang Nhu, Irvine, CA (US)

(72) Inventor: Hoang Nhu, Irvine, CA (US)

(21) Appl. No.: 16/209,241

(22) Filed: Dec. 4, 2018

Related U.S. Application Data
(63) Continuation of application No. 15/045,101, filed on Feb. 16, 2016.
Application No. 15/045,101 is a continuation-in-part of application No. 14/836,952, filed on Aug. 26, 2015, now abandoned.
(60) Provisional application No. 62/041,816, filed on Aug. 26, 2014.

(51) Int. Cl. H04L 29/08; G07G 1/00; H04W 4/80; H04L 12/18; G06Q 30/02; H04L 12/58; H04W 4/70

(52) U.S. Cl. CPC H04L 67/26; H04W 4/70; H04W 4/80; H04L 12/189; H04L 67/04; H04L 67/2804; H04L 67/22; H04L 67/02; H04L 67/12; H04L 67/10; H04L 67/28; H04L 67/125; G06Q 30/0241; H04L 51/38; G07G 1/009

(57) ABSTRACT

Devices are equipped with BLE modules that can scan, advertise, or both scan and advertise to form smart devices with beaconing capabilities. A cloud server can act as a bridge to allow a first user to remotely communicate with a second user based on the beacon generated by the smart devices. The cloud server, based on the beacon generated, can send commands to initiate one or more processes, such as to send reminders, to send open commands, or to send a digital key. Alternatively, the cloud server can act as a bridge between the first user and the second user based on the second user scanning and decoding a QR code using an app running on a smartphone used by the second user.

### FIELD OF ART

The present application is directed to sensors and systems for applications on products involving the internet of things (“IoT”) and for if this then that (“IFTTT”) applications and related methods.

### BACKGROUND

Bluetooth Low Energy (BLE or BT4.0 or Bluetooth Smart) has become a popular wireless standard since its first integration in the iPhone 4S and in almost all Android and Windows smartphones thereafter. Beacon messages, such as iBeacon by Apple, for advertising unique IDs and the recent announcement of EddyStone by Google are two exemplary implementations of a BLE-based protocol that broadcasts the identifier (ID) of a hardware device to nearby electronic devices. The technology enables smartphones, tablets and other embedded devices to perform actions when in close proximity to these advertising devices, such as to another device that advertises a beacon signal.

### SUMMARY

This disclosure describes a wide range of products that perform series of “IFTTT” actions. The products of the present disclosure share some basic blocks of “IFTTT” (or “If This Then That”) in the IoT “Internet of Things” market, including: Some action/event can trigger one or more sensors in an object (e.g., motion or a switch that detects the opening of an object); Then the object's Beacon-advertising signal wakes up to broadcast the object's ID; and Nearby electronic devices can detect this Beacon ID and can start to execute some desired pre-programmed actions.

The products and systems of the present disclosure are further useful when coupled with the additional optional components. Cloud-based services and push-notifications via a wifi-gateway and cloud services. This can enable an event happened at a particular location, such as in a user's home, to be notified on a remote cell phone.

In some examples, the products of the present system includes a device or instrument having a cap, a lid, or a door closed over the body or base and the door being opened or closed relative to the base can be detected and the status of the device or instrument can be used to initiate options or implement steps. For example, the products can involve the following a smart dispenser having a PCB with BLE module, a smart greeting/gift card with BLE module; and a smart doorbell with optional accessories, such as a smart mailbox, and a smart garage door opener.

The present disclosure also includes a low-cost beacon-based scheme, which may be implemented to automatically launch an app to connect a visitor and a homeowner for identification purposes. Once proper identification is made, the homeowner can, for example, share a digital eKey to allow temporary access to the visitor.

A still further aspect of the present disclosure is a smart garage door opener with smart doorbell accessory. Further aspects of the smart system are disclosed below.

Yet another feature of the present disclosure is the ability to integrate with social network sites, such as Facebook and Facebook Messenger. For example, the product of the present disclosure supports a Facebook (“FB”) Messenger-based scheme that securely and conveniently shares a digital eKey to allow visitor's temporary access to the home. Leveraging the recently announced FB-messenger platform that allowed payment services (for friends to send cash to one another), this Digital eKey/Garage Door opener (and 3rd-party doorlock API) provides end-to-end home-access management support needed by certain sharing services, such as AirBnB home renters, for example. The present disclosure can use IFTTT actions as a way to authenticate a user. This same Digital eKey scheme can be generally applied to many other markets such as bike rental, video game rental, or even to allow parents to throttle their kids' TV-time.

The present device, system and method support capabilities and functionalities. The system provides a low-cost approach that involves a PCB, BLE chip, button switch/or dome switch, a coin-cell battery and holder, and an optional button input. There can be zero power consumed by the PCB unless the housing that it is attached to is temporarily opened. In case the user forgets to close the assembly after a certain time, the BLE chip can automatically go back to sleep mode to conserve battery life.

The system allows the PCB to be reprogrammed wirelessly to broadcast different Beacon info/messages thereby requesting the receivers' application software to perform different desired tasks.

The optional button input on the PCB can support additional services such as: to allow a mailman to push the button to remotely ring the doorbell when he opens the mailbox; a pillbox that can link to the pharmacy for refill order; and a greeting card that can control/skip to the next content being played.

Having an Index ID stored in the sensor's memory, such as in the PCB of a pill dispenser, can be used by a nearby gateway (or smartphone app) to retrieve information from a cloud database about the medicine prescription. Similar to the traditional barcode printed on a pill bottle's label, this Index ID can be generated at the doctor's office or at the pharmacy and can be accessible by the doctor, the pharmacy or pharmacist, or personnel thereof. Via this index ID, cloud services can enable a patient to also have similar access to the medicine automatically from his home, offering new, unique capabilities and services.

Based on the prescribed medication schedule obtained from the Index ID, a schedule can be stored in the gateway, phone app, or the cloud. The system can detect whether the user opens the bottle at or approximately within an acceptable time frame of the correct prescribed time and can alert the user or his caretaker if this is not the case. The system can also remind the user in case he forgets to take his medicine. The history log of these events can be stored in the cloud and can be reviewed by the user, his caregiver, and/or his family members.

Via voice-recognition and text-to-speech, such as from Siri or Amazon Alexa AVS, etc., upon opening the bottle, the system can read the medicine information out loud, warn if it is approaching the expiration date, or which patient it is for to avoid mismatch, to name a few examples. Conversely, if the user forgets to take the medicine by a certain prescribed time, the voice system can wake up and remind the user and/or the caregiver via phone notification. Further, a digital flag/bit can be stored in the sensor's memory to indicate whether the bottle has been opened before reaching the patient, which can be used as a digital tamper-proof mechanism.

Together with software support, in the gateway or phone app running on a smartphone, both at the pharmacy and at home, the index ID can serve to identify if the user is the right person for the pill bottle. This capability can eliminate or reduce the pharmacy's liabilities in mishandling of the pill bottle, such as delivering it to the wrong person. Additionally, after opening the bottle, a password may be required to ascertain the user is the right person. The smart dispenser can also be programmed to place an auto-refill order with the pharmacy when the bottle is nearly empty.

PCBs with BLE modules disclosed herein can be used to communicate, send messages, detect, monitor, authenticate, and/or provide access to smart door locks, smart garages, and other smart devices. In an example, the beacon broadcast following a greeting card's opening event wakes up the firmware running in a nearby gateway or a phone app to perform various tasks that were preprogrammed, such as: to download a song or a video clip and play on the phone or on a display device such as SmartTV connected to the embedded platform with video/audio output capabilities. The gateway or phone app can also control various appliances in the house such as lights, TV, music receiver, etc.

The smart doorbell of the present sent can replace the traditional doorbell with the following added capabilities: notifies the home owner's phone when a PIR motion is detected at the front door or when the visitor presses on the bell button.

For a smart doorbell system with a without Wifi module or internet access, the system can use the visitor's phone app, which can be launched when the smart doorbell's Beacon is detected. This system can use the visitor's phone as a gateway to perform various tasks, including display a virtual bell button on the phone's user interface (UI); allowing the virtual bell button to send notification to the home owner's phone with ID of the visitor, such as the visitor's Facebook ID. The home owner can view/check the visitor's ID and can connect with the visitor via Facebook messenger for chat or video call to further identify the visitor.

For a smart doorbell system with Wifi, internet access, and speaker/microphone, notification can be sent to home owner's phone when the PIR motion or bell button event occurs. The visitor and the owner can be connected via 2-way audio using the built-in speaker/microphone of the smartphones. Optionally, they can also be connected via FB-messenger using the visitor's phone as the gateway.

With Wifi internet connection and voice-based platform, such as Amazon Alexa or Apple HomeKit/Siri, the smart doorbell can support many new features. Personalized greeting messages and private messages can be sent for each visitor, after positive identification. Special message for mailman or Fedex personnel can also be delivered or provided, including instructions to leave the package in the garage or secured storage location, as they can be remotely controlled.

The visitor can tell who is in the household/office/multi-tenant building the visitor is looking for so Alexa or other voice-based system can route notification only to that person's phone. The visitor can also leave recorded messages for the homeowner.

Where a front door is not equipped with DC power for a doorbell, smart doorbells of the present disclosure can still be used. For example, a door to a classroom at a high school can be equipped witch such doorbell. The smart doorbell can be plugged into a DC power adapter inside the home or the room near the door. When the visitor approaches the door, Beacon signal from the smart doorbell launches an app on the visitor's phone to display a virtual bell button. The visitor can click on this virtual bell to send a push-notification to the owner's phone or the teacher's phone, as examples. The owner can then connect with the visitor via Facebook Messenger to further identify the visitor before sending him a digital eKey for accessing the home or the classroom, as examples.

Another aspect of the present disclosure is a smart doorbell with optional garage door opener accessories. After positive identification of the visitor, if needed, the home owner can send a digital eKey to give temporary garage door access or access to other door locks using API interface so that visitor, such as a FedEx personnel, can drop off a package in the garage while the owner is away from home.

Unique features of the digital eKey can include verification, remote delivery, ability to limit how the eKey is used, etc. The eKey can be set up to be valid for one time use or for a limited time period. The eKey can be sent securely and, optionally, only to a particular visitor's phone that has been paired for use with that eKey. The eKey can be sent via a chat platform such as FaceBook Messenger together with its Getsapp for Messenger scheme. This is based on the same high security FB-Messenger Payment Services that is presently available. The digital eKey can be used by the app and server of the present disclosure to identify who the visitor is and his temporary access levels, which can be approved and configured by the home owner.

The digital eKey of the present disclosure is not limited to a smart doorbell product. It can also be used in other applications, such as with a smart power plug product to allow parents to time-limit their kids' TV time or video game time.

In another embodiment, a garage opener can act as a Wifi-gateway to monitor and control the garage door remotely. The main garage opener board can monitor the state, such as open or close state, of a garage door via a Bluetooth Smart-based tilt sensor attached to one of the panels of the garage door.

The system can be expanded to monitor additional doors, and other Bluetooth smart devices, via additional Bluetooth tilt sensors or motion sensors. Further, by incorporating Bluetooth Mesh networking and repeaters, the BLE scanning and monitoring capabilities can be expanded beyond the normal range to cover a larger area.

An optional video surveillance camera can be incorporated. The camera can snap and store photo when the garage door is opened for or by the visitor.

The process of linking communication between a visitor and a home owner or between a first user and a second user can be initiated by scanning a QR code. The QR code can be set up by the first user or home owner and the QR code can be detected to allow the two to communicate, such as chat.

Aspects of the present disclosure further includes a system for monitoring and tracking an open event comprising: a battery operated PCB with a BLE module; wherein said BLE module is programmed to emit a beacon when the a first surface is movable relative to a second surface; said beacon defining an open event; and a cloud server programed to perform at least one of record the open event in a database and send a command to a smart device upon receipt of the open event.

The s smart device can comprises a smartphone, a tablet, or a computer.

The system can further include a gateway, and wherein the gateway or the smart device can be configured to send the open event to the cloud server.

The first surface can be a cap or a first layer of a card and the second surface can be base or a second layer of a card.

The system can further comprise a smart TV and wherein the command from the cloud server can play a music tune, a video clip, or display a picture.

The cap and the base can be a dispenser bottle for storing medication, and wherein an index ID can be stored in a memory on the PCB.

The Cloud server can be programmed to activate a reminder protocol based on a number of times the cap is opened relative to the base.

The first surface can be a door on a mailbox and the second surface can be the box of the mailbox.

The present disclosure can further include an integrated home access management system comprising: a smart doorbell equipped a BLE module and programmed with a first doorbell ID; a first smartphone having supervisory control over the smart doorbell; a smart doorbell App running on a second smartphone; said smart doorbell App receiving said first doorbell ID wirelessly; a cloud server with a database having a plurality of doorbell IDs including said first doorbell ID; and a chat tool to enable chatting between the first smartphone and the second smartphone.

Yet another aspect of the present disclosure can include a system for facilitating communication between two or more parties using QR codes comprising: a cloud server with a database; a web-browser app programmed to allow a first user to register a first ID and associating the first ID with a first QR code; a first smartphone associated with the first QR code; an application running on a second smartphone programmed to decode the first QR code into readable text; and a communication option to link the second smartphone with the first smartphone based on the readable text.

These and other features and advantages of the present devices, systems, and method will become appreciated as the same becomes better understood with reference to the specification, claims and appended drawings.

### BRIEF DESCRIPTION OF THE DRAWING FIGURES

FIGS. 1A and 1B are schematic depictions of a storage dispenser comprising a PCB with BLE module in accordance with aspects of the present disclosure.

FIGS. 2A and 2B are depictions of a storage device comprising a hinged door or lid that can be used with a PCB with BLE module in accordance with aspects of the present disclosure.

FIGS. 2C and 2D are schematic depictions of a storage dispenser comprising a PCB with BLE module in accordance with alternative aspects of the present disclosure.

FIG. 3 is a system diagram showing an application of a smart dispenser in accordance with aspects of the present disclosure.

FIG. 4 is a system diagram showing an application of a smart dispenser with a Cloud server in accordance with aspects of the present disclosure.

FIG. 5 shows a smart greeting card with a PCB and BLE module in accordance with aspects of the present disclosure and FIG. 5A shows a slider usable with the greeting card.

FIG. 6 is a system diagram showing an application of the smart greeting card with a Cloud server in accordance with aspects of the present disclosure.

FIGS. 7 and 8 show a smart mailbox comprising a door and a box comprising a PCB with BLE module in accordance with aspects of the present disclosure.

FIG. 9 is a system diagram showing an application of an integrated home access and control system with a Cloud server in accordance with aspects of the present disclosure.

FIG. 10 is a system diagram showing an application for authenticating and sending a digital key for a user to use to access a smart device, such as a smart door lock or a smart garage door opener.

FIG. 11 is a system diagram showing an application of an alternative integrated home access and control system with a Cloud server in accordance with aspects of the present disclosure.

FIG. 12 is a system diagram showing an application of yet another alternative integrated home access and control system with a Cloud server in accordance with aspects of the present disclosure.

FIG. 12A is a system diagram showing an application of a QR code with a Cloud server in accordance with aspects of the present disclosure.

FIG. 13 shows an exemplary QR code that is usable with aspects of the present disclosure.

FIGS. 14 and 15 show different screens or pages on a user smartphone after a QR code is scanned and the information decoded into text.

### DETAILED DESCRIPTION

The detailed description set forth below in connection with the appended drawings is intended as a description of the presently preferred embodiments of smart devices and systems utilizing these devices provided in accordance with aspects of the present devices, systems and methods and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

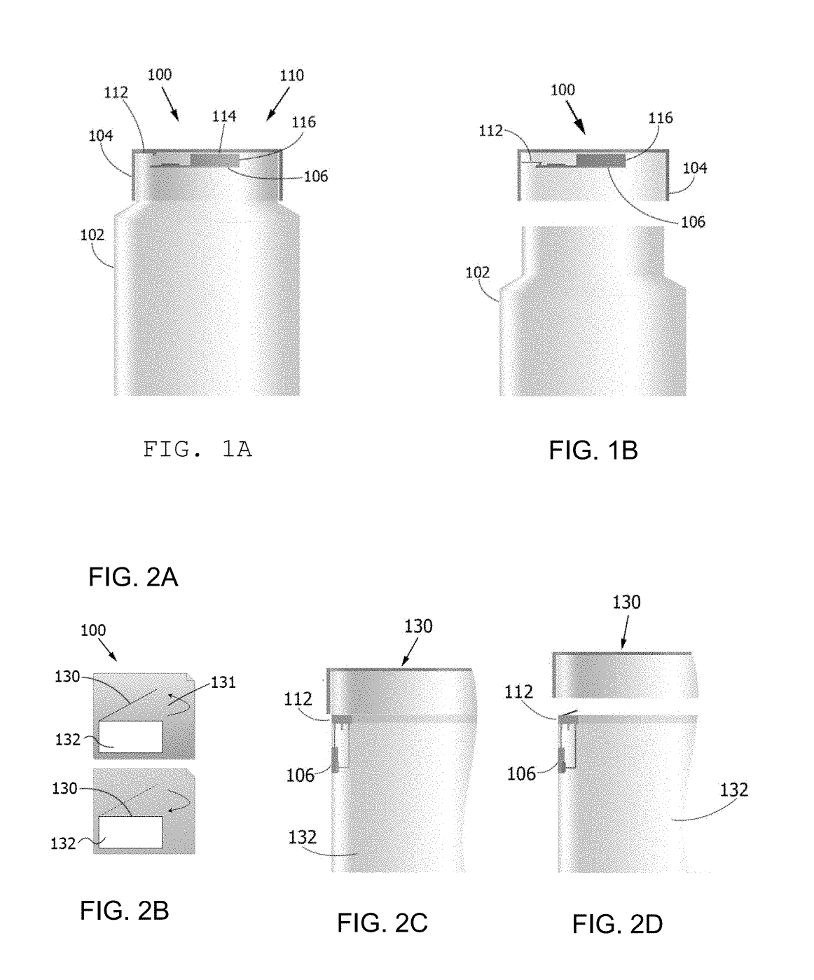

With reference to FIG. 1A, a storage product or device 100, such as a bottle and cap or lid, a storage tray with a base and a lid, or a container having a first section detachable from a second section, is shown comprising a smart component of the present disclosure. In an example, the storage device 100 comprises a bottle 102 having an interior cavity for storing or holding some contents with a cap 104 having a smart component comprising an integrated circuit chip or BLE printed circuit board (PCB) 106 attached to the cap or lid 104, such as to the inside bottom of the cap 104, which more generically can be considered attached to a second section that is detachable from a first section of a storage device. The IC chip or PCB 106 can comprise electronic circuits configured to emit, transmit, or broadcast Beacon signals using BLE. The IC chip or PCB 106 can be referred to as a beacon device and can be understood to use BLE circuits to transmit small amounts of data to within a finite range, such as to about 20 meters. As is understood by a person of ordinary skill in the art, the BLE can emit a beacon signal that includes specific or unique ID, such as a binary or digital code. The unique ID emitted by the BLE emitting device can be detected by another device and the detected information can be processed to implement aspects of the present disclosure, as further discussed below. The PCB 106 used with the storage device 100, or with other devices discussed elsewhere herein, can optionally include a button for user input or to add capabilities. When used with the storage product 100 of the present disclosure for medications, activation of the button can notify the pharmacy to refill an order, as an example.

The storage product or device 100 of the present disclosure may be usable as a pill or medicine bottle or can be used as a box or a container for other purposes, such as for storing nutritional powder blend or for storing syrup or liquid, including medicinal and non-medicinal types. The storage device 100 can also be a safe, a refrigerator, or a storage chess for storing contents and wherein the act of opening of the storage device will cause a BLE device or chip to transmit a signal that can then be tracked or monitored. The storage device can have a lock or be without a lock.

The BLE-Beacon chip 106 can be configured to work with a schedule or a program in which intervals, routines, and/or regiments are to be kept, tracked, or recorded. For example, the storage device 100 can be used as a medicine bottle for storing a plurality of dosages or pills and wherein the dosages or pills are to be taken in accordance with a medication schedule and wherein the IC chip or PCB 106 mounted with the storage device 100 with BLE-Beacon capability and a cloud server of the present disclosure can provide the following exemplary features or advantages: (1) replace or append to traditional printed instructions or information by storing medication-related information in the BLE chip's memory instead of on labels, printed instructions, or barcodes; (2) store medication-related information in the Cloud and using the BLE chip to determine whether the storage device has been opened in accordance with the medication schedule stored; and/or (3) provide reminders to the user or patient to take the prescribed dosage according to scheduled intervals.

Advantageously, the storage product or device 100 comprising the IC chip or PCB 106 with BLE-Beacon capability of the present disclosure can turn a typical prior art product or device, such as a typical storage device 100, into a smart device 110 capable of tracking and monitoring, among others. Thus, a smart device is understood to include a device, such as a container with a lid, door, or cover for storing, a cupboard, a refrigerator, a doorbell, a lock, that is equipped with a PCB 106 so that the device can advertise its electronic signals, can detect motion, be tracked, be monitored, communicate electronically, or combinations thereof. For example, as further discussed below, the smart device 110 of the present disclosure can include a smart mailbox, a smart doorbell, a smart garage door controller, a smart doorlock, a smart storage device, etc.

As further discussed below, the PCB 106 of the smart device 110 of the present disclosure can detect the opening of an object using motion detection or a switch, such as detection of a cap being opened by a user. Then the object's PCB wakes up and the beacon-advertising signal programmed in the IC chip or PCB 106 can broadcast the object's ID or the ID associated with the bottle and the PCB. The ID can be a Beacon ID and can include a unique sequence number that can be distinguished from a Beacon ID of another smart device 110. Nearby electronic devices with BLE modules can detect this Beacon ID and upon such detection can initiate one or more desired pre-programmed actions. Thus, the storage product 100 of the present disclosure may be used to stream line medication prescription identification and processing and labeling at the pharmacy, at home or in a hospital, to facilitate timely consumption of prescribed dosages, among other applications.

By using a switch with a PCB 106 that is battery powered, zero power is consumed unless the housing that the PCB is attached to is temporarily opened. In case the user forgets to close the device or assembly, such as the storage device or other smart devices discussed elsewhere herein, after a certain time, the BLE chip can automatically go back to sleep mode to conserve battery life.

The products of the present disclosure, such as the smart devices of the present disclosure, are further useful when coupled to Cloud-based services and push-notifications, via WiFi-gateway and Cloud services. These features can relay activities at a particular location, such as in a user's home, to a cell phone or tablet that is remote from the location. The Cloud-based services can further be configured to implement instructions following receipt of the tracked activities.

To expand the range that the smart devices 110 of the present disclosure can communicate with other smart devices, BLE-Mesh networking firmware can be incorporated. For a typical smart device with BLE Beacon capability, the Beacon signal can only be detected by a detection device or an electronic device if the latter is in close proximity (e.g., within 10-20 m range) of the source of the BLE Beacon. To cover a larger range or to extend the range of detection so that more devices with Beacon signals can be monitored or to monitor a device with Beacon signals further than 20 meters away, BLE-Mesh repeaters running BLE-Mesh networking firmware can be used, as further discussed below.

The smart device 110 of the present disclosure can have both mechanical and electrical components. FIG. 1A shows the storage bottle 100 in a closed state with the cap 104 coupled to the base, housing, or bottle 102 and the switch 112 is in an open state. This cap or lid 104 closed state or switch 112 open state disconnects the power source, such as a battery, from the IC chip or PCB 106 with BLE circuits. In the cap closed state or switch open state, the Beacon signal is OFF or the Beacon signal is not being emitted by the BLE module of the IC chip or PCB.

When the storage bottle 100 is opened, signified by the switch 112 being in a closed state and the cap 104 separated from the bottle 102, as shown in FIG. 1B, power to the BLE circuit is provided and the IC chip or PCB 106 is energized and can begin to advertise its unique sequence number via Beacon signals. Nearby devices can detect the Beacon signals of the smart device 110 and the detected information can be used to alert a smart phone, sound an alarm, initiate a program, or trigger other events, as further discussed below.

In an example, the storage bottle 100 has multiple compartments, such as seven compartments for each day of a 7-day week. In another example, the bottle 100 has a single interior cavity or compartment for storing a volume of liquid or a plurality of individual pills. In other examples, consumable goods are stored inside the bottle 100, such as food, candy, etc. When the storage bottle or container 100 is closed, as shown in FIG. 1A, the switch 112 is in the open state and power from the onboard battery or power source 116 is disconnected from the BLE circuit 106. The Beacon signal is OFF or is not being advertised by the BLE circuit when the switch 112 is off, or in this case in the switch open state.

When the cap 104 is opened or separated from the storage bottle or box 100, the bottle is understood to be opened, which causes the switch 112 to close or be in a closed state. This closes the circuitries and power is provided to the BLE circuit 106, which then initiates its internal program to start advertising its unique sequence number so that nearby devices can detect and process the advertised information, such as advertised Beacon signals, as further discussed below.

The switch 112 may include a biasing means, such as a leaf spring or other biasing structures, and utilizes the space or gap between the cap 104 and the rim or the opening of the bottle 102 to change state between open and closed, or vice-versa. Also shown in FIGS. 1A and 1B is an adhesive layer 114 for securing the BLE circuit or chip 106 to the cap 104. In other examples, double-sided tape, detents, bonding material, or glue may be used to secure the BLE circuit 106 to the cap 104.

FIG. 2A is a schematic representation of a storage product 100, which can be a box, a base, or a housing 132 with an interior having one or more compartments having a lid, a door, or cap 130. As shown, at least part of the lid 130 is spaced from the base 132 in an open state. The separation between the lid and the base can be used to open/close a switch. The lid 130 can be hinged to the base 132 or can separate completely from the base to open and subsequently placed against the base 132 to close the storage box 100. As shown, the lid 130 is hinged to the base and has an edge that is spaced or separated from the base in the storage product open state.

FIG. 2B is a schematic diagram showing the storage product 100 of FIG. 2A in a closed state, in which the lid 130 is closed against the opening of the base 132. The storage product 100 of FIGS. 2A and 2B depicts an embodiment in which the lid or cap 130 does not completely separate from the base 132 to open the storage product 100. However, a variable gap 131 is provided that changes when the lid is completely closed against the base and when the lid is movable relative to the base to expose the interior space of the base.

In an example, a BLE circuit, similar to the IC chip or PCB of FIGS. 1A and 1B, can be mounted to the base 132 instead of the lid 130. An example of a PCB mounted to the base instead of the cap is shown in FIGS. 2C and 2D. The PCB can be activated when the variable gap 131 changes from a closed state having a first gap dimension, such as when the lid is abutted against the opening of the base, to an opened state having a second gap dimension, such as when the lid is pivoted relative to the base. The second gap dimension is understood to be larger than the first gap dimension. Thus, a smart storage device of the present disclosure can include a cap that is entirely removable or separable from a base or one that is hinged to the base and wherein the smart storage device has an IC chip or PCB with a BLE module for advertising Beacon signals.

FIG. 2C is a side view of a storage product 100 in a closed state, which shows a cap or lid 130 closed against the opening of a base or bottle 132. The storage product 100 comprises a BLE circuit 106 and a switch 112. As shown, the BLE circuit 106 and the switch 112 are mounted or located in or on the base 132. In the closed state, the switch 112 is pushed by the constraint between the lid 130 and the base 132 to open the circuit to disconnect the power source to the BLE circuit. As shown in FIG. 2D, when the lid 130 is separated from the base 132, the switch 112 is no longer constrained and moves to close the circuit with the power source, which then energizes the BLE circuit 106 to begin advertising its Beacon signals, which contains a unique sequence number. Nearby devices can detect and process the advertised information, as further discussed below. In the present embodiment, the BLE circuit 106 is a BLE PCB type device with a battery for powering the circuit when the switch 112 closes.

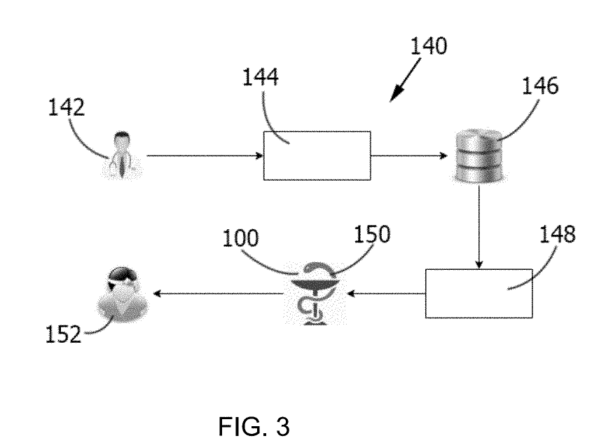

FIG. 3 is a process flow diagram 140 depicting a method of use of the present smart device 110, such as one of the smart devices shown in FIGS. 1A-2D. At point or step 142, a doctor prescribes a medicine and a dosage for a patient, which can represent any number and type of commercially available medicines and can be in analog form, such as on a piece of paper having the prescribed medication, or in digital form, such as by calling in or typing into a computer for uploading to a network device. There may be multiple medications and multiples dosages but for purposes of the following discussions, only a single medication and a single dosage will be discussed.

The prescribed dosage and medication are represented at point or step 144. This information 144 is then sent to the pharmacy at 148, such as by faxing. The pharmacy 148, or a worker at the pharmacy, will then enter this prescription information into a database 146 in the cloud server/storage. In another embodiment, the doctor or an assistant at a clinic or hospital can enter the prescription directly into the Cloud server database 146. An “Index ID” is generated to indicate the location of this prescription in the database and can include other information, such as a prescription calendar, explanation about the prescription, refill information, etc. Then this “Index ID” is stored in the memory of the BLE circuit 106 located with the smart storage device, as discussed previously in FIGS. 1A-2D. The chip 106 can then be mounted to the cap or the bottle of a storage device 100 at 150 to turn the storage device into a smart device 110. When a patient 152 or someone on the patient's behalf picks up the smart device 110 from the pharmacy, it will contain the prescribed medicine and will have a PCB 106 mounted therewith with information programmed into the PCB that can be monitored, tracked, checked, etc. by or using the pharmacy cloud database 146. In an example, the Index ID stored in the memory of the BLE circuit 106 can serve to identify if the user is the right person or intended person for the particular medication or particular bottle. This can help to eliminate the pharmacy's liability in mishandling of the pill bottle, such as delivering it to the wrong person. Additionally, after opening the bottle, a password may be required to ascertain whether the user is the right person.

In an example, the PCB 106 on the smart dispenser can have a digital flag or bit stored in the PCB's memory to indicate whether the bottle has been opened before reaching the patient. This information can be used as a digital tamper-proof indicator.

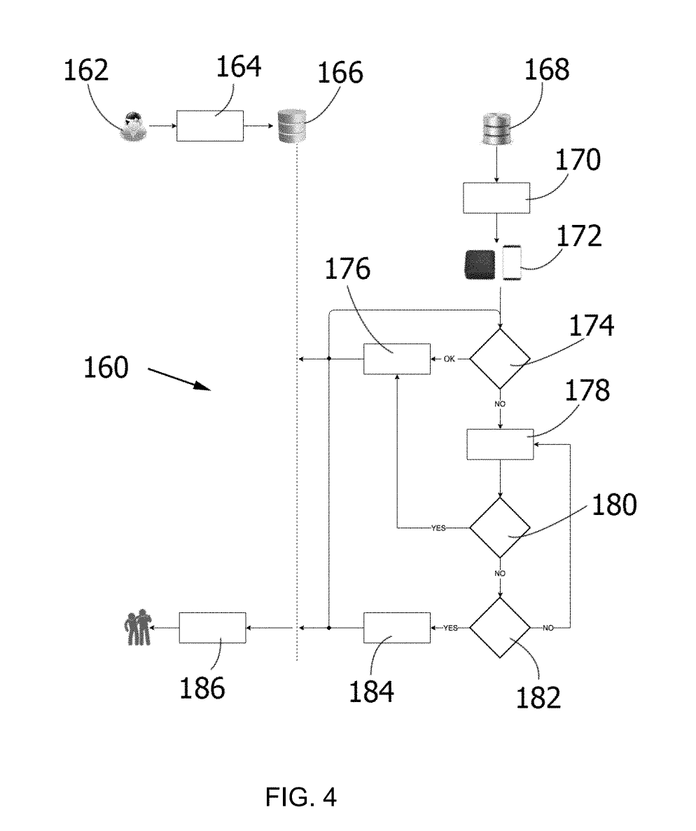

With reference now to FIG. 4, a process flow diagram 160 depicting another method of use of the present smart device 110 is shown. In the present exemplary process, a receiving electronic device, such as a smart phone, a tablet, and/or a laptop, may be configured to receive and process advertised data from a smart device 110 that advertises information using BLE to generate Beacon signals, such as those discussed elsewhere herein, including the storage device of FIGS. 1A-2D. In the present embodiment, the method can represent a process of monitoring and recording when a smart device is activated and using the information to notify the registered user, via his smartphone, tablet, or computer. The present process 160 can be used in combination with the process 140 of FIG. 3.

At step or point 162, a user, such as a patient, someone who is scheduled to take a prescription, or any user who wishes to receive a notification from the present system, sets up a receiver phone number, ID or other user specific information at 164 to receive notification related to a smart device 110 of the present disclosure, such as information related to the smart storage device 110 of FIG. 3. The receiver phone number/ID 164 is stored in a medication tracking database 166 on the Cloud using a web browser dashboard. The medication tracking database 166 on the Cloud server can be the same as the database 146 of FIG. 3. In one example, the user logs onto a web browser dashboard and provides the receiver phone number/ID 164, which is then used by a program in accordance with aspects of the present disclosure to send information to the entered phone number/ID related to a smart device 110 that the user wishes to receive information about. The medication tracking database 166 can include information, such as a scheduled calendar, of a patient. In an example, as the user sets up information on the medication tracking database 166 on the cloud server, the program associated with the database 166 and the cloud server can retrieve the medication schedule for the patient and display the information for the user's review.

The pharmacy cloud database is also shown at 166, to the right of FIG. 4, and can be thought of a database (i.e., a database on a Cloud server) that can be connected from anywhere with Internet access. The pharmacy cloud database 166 can contain the patient's medication schedule, among other data that can be stored therewith. The patient's medication schedule can optionally be stored locally in a dedicated gateway 170 or in an App calendar 172. The dedicated gateway 170 can reside in an embedded system PCB board at a local site, and the App calendar 172 can reside in a smart phone or a tablet that is BLE enabled. The gateway 170 or the phone app 172 monitors whether medication is taken and relays this event to the cloud server 166 for data logging and notification. In an example, when a cap on a smart device 110 is opened, the BLE module is activated and sends a Beacon signal, which can be registered as an OpenMe event and the event can be detected, such as by the gateway 170 or the smartphone 172, and relayed to the cloud server 166.

The information from the cloud database 166, in the dedicated gateway 170, or in the App calendar 172, can include a dosage schedule or medication schedule, which can include both quantity and frequency. The smart device 110, such as a storage bottle with a BLE chip at 150 of FIG. 3, is configured to interact with the dedicated gateway 170 and/or the App calendar 172 for the latter to remind/notify a caretaker or patient to take medication via the tracking of the OpenMe event of the smart device 110, as further discussed below. When the medication schedule is stored in the Internet-based cloud database 166 and in the local dedicated gateway 170 or in the App calendar 172, the “reminder’ feature can continue to work even when Internet connection is down or not available.

At a scheduled time at 174 within a programmable plus or minus range, as prescribed by a doctor, a cap of a smart device 110 is opened at 176 so that the BLE circuit located inside the smart device is energized by a power source, as previously described. The “open event” at 176 is then logged to the database in the Cloud server at 166. The information can be logged automatically when the BLE signals emitted by the smart device 110 of the open event are detected by the gateway 170 or the App calendar 172 running on the smartphone or tablet and the latter communicating with the Cloud server at 166. This information can be registered as an “open event.” In some example, the event can also register as a consumption of a prescribed medication and an indication that the patient, or a service provider for the patient, remembers the medication schedule.

If there is no open event at the scheduled time 174, as triggered by the lack of any Beacon signal at the scheduled time or the gateway 170 and/or the App calendar 172 not detecting any Beacon signal from an associated smart device 110, the process moves to step 178 to initiate a reminder protocol. In an example, the gateway and/or the device running the App calendar sounds an alarm to remind the patient, or the service provider caring for the patient, to take his medication. At 180, the gateway and/or the device running the App calendar checks for an Open Event again. Whether triggered by the reminder or the patient simply remembers the schedule and opens the medication bottle 100 at 180, the “open event” is relayed by the gateway and/or the device running the App calendar at 176 to record the event on the Cloud server at 166.

If the smart device is not opened, because the BLE circuit on the smart device 110 is not energized or activated to advertise a Beacon signal, the process moves to step 182 to further implement the reminder protocol. A count is recorded or tracked at 182 to determine whether the reminder has exceeded certain pre-set or pre-determined number of reminders. If the number of reminders is exceeded, it can be recorded as a failure by the patient to consume the prescribed medications. If the number of reminders has not been exceeded, the smart device can be programmed to send additional follow up reminders at 178. If the number of reminders has been exceeded, the program moves to 184 and sends a “Failed-to-Take” event to be recorded by the medication tracking database 166. The information is sent by the gateway and/or the device running the App calendar at 176 to record the event on the Cloud server at 166. The program also moves to step 186 to notify the caregiver/user, set up at step 164, of the Failed-to-Take event.

In an example, if a particular medication is to be taken once every 8 hours, at least three “open events” should be recorded in an approximate 24-hour period, give or take. If more than 8 hours have elapsed between two “open events,” the system can interpret the information as a failure or a “Failed-to-Take” event, which is performed at 184. In an example, the failed notice may be recorded on the Cloud server 166. The information recorded for a particular user or patient may then be sent to a family member or caregiver at 186 to notify that person of the patient's compliance or adherence to the prescribed dosage and schedule.

Another unique feature of the Smart Device 110 is the capability to obsolete the barcode/label-printing that is currently used by a pharmacy to label a bottle. Using a voice-command and text-to-speech feature, such as Apple's Siri or Amazon Alexa AVS, etc. and upon the smart device bottle 110 being opened, the system 160 can look up the medicine or prescription information from the cloud database 166, via the Index ID, and can then read the information out loud, such as over an audio system in the gateway or in the smart phone, tablet or computer. The voice-command and text-to-speech feature can also be programmed to warn if the prescription is approaching the expiration date, whether it is time to auto-dial the pharmacy for refill, and can describe the type of medication or the symptom the medication is treating to avoid consuming an incorrect dosage or type, such as when the patient may have multiple medicine bottles in his cabinet.

In an example of using a voice-command and text-to-speech feature, a microphone in either the gateway 170 or the smartphone app 172 can capture the patient's voice command or the voice of his caretaker to inquire whether the patient has met his dosage for the day, as an example. This audio information is processed by a Cloud-based voice server, such as Amazon Alexa voice server. Then using information in the Cloud database 166 of the present system 160, such as accessing the database 166 and querying the number of times the patient has taken his medication over the past 24-hour period, the voice server sends the results back to either the gateway 170 or the smartphone 172 for reading out loud the answer via the speaker in these devices. Similarly, when the smart bottle 110 is opened, its medicine information is retrieved from the Cloud server database 166 and is returned to either the gateway 170 or the smartphone 172 that then plays the audio regarding the medicine information using Text2Speech software.

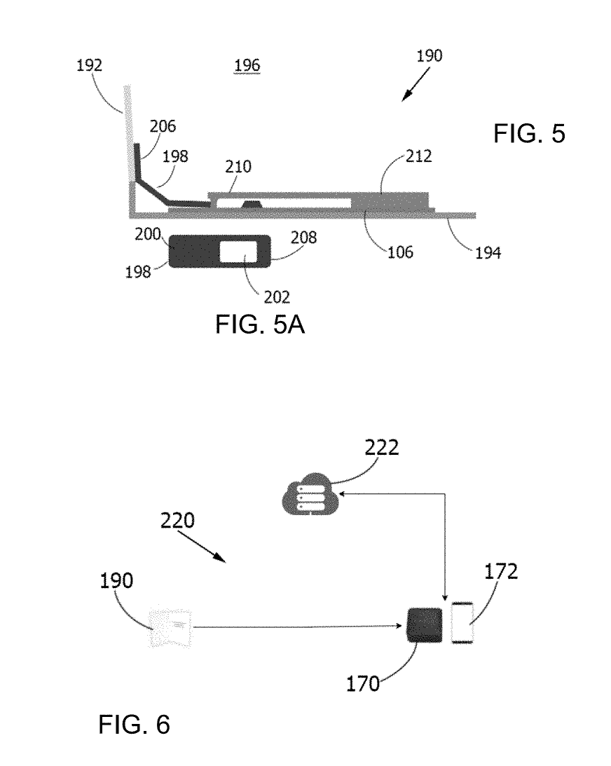

A further aspect of the present disclosure includes an apparatus and a method for practicing and making the apparatus involving a smart greeting card. In an exemplary embodiment, a BLE Beacon board or chip 106 is inserted, such as glued or clipped, onto the inside of a greeting card 190 (FIG. 5), which has a first greeting card layer 192 and a second greeting card layer 194 defining a card interior 196. The BLE Beacon board 106 is configured to broadcast when the first greeting card layer 192 is rotated relative to the second greeting card layer 194, or vice-versa, to open the greeting card. The opening of the greeting card 190 closes the power circuit of the electronics to energize the BLE Beacon board 106 to transmit a unique ID. The transmitted signal can be detected by a BLE receiver device as an indication that the greeting card 190 has opened and can then operate other programs in accordance with aspects of the present disclosure to perform follow up functions, such as to play a song on a stereo or a smartphone, as further discussed below. In an embodiment, the BLE receiver device that detects the BLE signal from the greeting card 190 can be a dedicated gateway or a smartphone running a greeting card App, similar to the scenario discussed above for receiving signals from the smart bottle dispenser.

In an example, a slider 198 is connected to the first greeting card layer 192, such as to the inside surface of the first layer 192, and is movable with the first greeting card layer. For example, the slider 198 can have a first end 206 that is glued or clipped to the inside surface of the first greeting card layer 192. The opposite or second end 208 of the slider 198 can be free floating, or not anchored. Optionally, the second end 208 can be secured to the BLE Beacon board 106 or to the second layer 194. As shown in FIG. 5A, the slider 198 has a wall layer 200 with an outer perimeter and an inner perimeter defining an opening 202.

When the slider 198 moves by the movement of the first greeting card layer 192 relative to the second greeting card layer 194, the opening 202 on the slider 198 shifts to move the opening 202 relative to other parts of the BLE Beacon board 106. This movement enables a metal conductor 210 to make contact and close its circuit, which then allows power from a power source 212 to energize the BLE beacon board 106. The metal conductor 210 therefore acts as a switch and when the slider moves to move the opening 202, the metal conductor forms a closed circuit through the opening 202 to then allow power from the power source 212 to energize the BLE Beacon board 106. Once energized, the BLE Beacon board 106 can begin to broadcast. If the second end 208 of the slider 198 is secured or anchored, movement of the slider can cause flexing or bending of the PCB 106 and/or the second layer 194 to close the loop of the metal conductor 210.

Thus, following a Greeting card's opening event and following the BLE beacon's broadcast, the beacon signal can be detected by a gateway, a smartphone or a tablet running a firmware for a phone App. The gateway or phone App can then perform various desired tasks that have been preprogrammed in the embedded firmware or the phone App running a greeting card app.

When the greeting card 190 is closed by moving the first and second greeting card layers 192, 194 towards one another to close the interior 196, the slider 198, which can be made from a plastic material or other non-conductive material, blocks the metal conductor 210 from making contact with the PCB traces on the BLE Beacon circuit, thus disconnecting the PCB from the battery or power source 212 and turning the BLE board OFF. When the card is opened, the plastic slider 198 slides to allow the metal conductor 210 to make contact with PCB traces via the opening 202 on the slider 198, thus powering ON the BLE PCB 106 and thereafter the Beacon signal starts broadcasting. This Beacon signal can trigger the App (in a nearby phone or an embedded gateway board) to run to perform some local or cloud-based services as preprogrammed.

In the greeting card 190 embodiment of FIGS. 5 and 5A and as shown in the process flow diagram 220 of FIG. 6, the greeting card 190 is equipped with a BLE Beacon circuit or chip 106 of the present disclosure, which is operable by a power source 212, such as a battery, that has a circuit that can be connected or disconnected by a switch, which in the present embodiment embodies a slider 198 but can include any number of structures to permit opening and closing of a circuit. In the present example, the switch is activated by flipping the greeting card open, which then allows the BLE Beacon chip 106 to be energized to begin advertising. The present embodiment can further be practiced with a gateway 170 or a smartphone 172 with a greeting card App installed. Thus, when the greeting card 190 is opened and an “open event” is detected by the gateway or smartphone, the greeting card App preloaded therein, via electronics and software on the gateway or smartphone, receives the signals from the smart card and performs certain pre-programmed functions, which are further discussed below.

The present embodiment may also be practiced with a Cloud-based server 222, which can be accessed via the gateway 170 and/or the smartphone 172. For example, a user can open a web-browser dashboard and input certain songs, video clips, jokes, or other parameters associated with the greeting card. Then upon detection of the open event by the smartphone 172 or the gateway 170, the Cloud based server 222 can be queried to retrieve information to play a song, play a vacation video clip, or load pictures on the screen of the smartphone. Other actions are contemplated including launching a website or another App on the smart phone. In other embodiments, a SmartTV is loaded with the greeting card App and performs similar functions as the smartphone. For example, one or more pictures, one or more video clips, one or more songs, or one or more stories can be aired on a SmartTV located within the same space or vicinity of the greeting card 190 after the greeting card is opened. When a button is used with the PCB on the smart greeting card, it can allow the recipient of the card to push the button to advance to the next content, as an example.

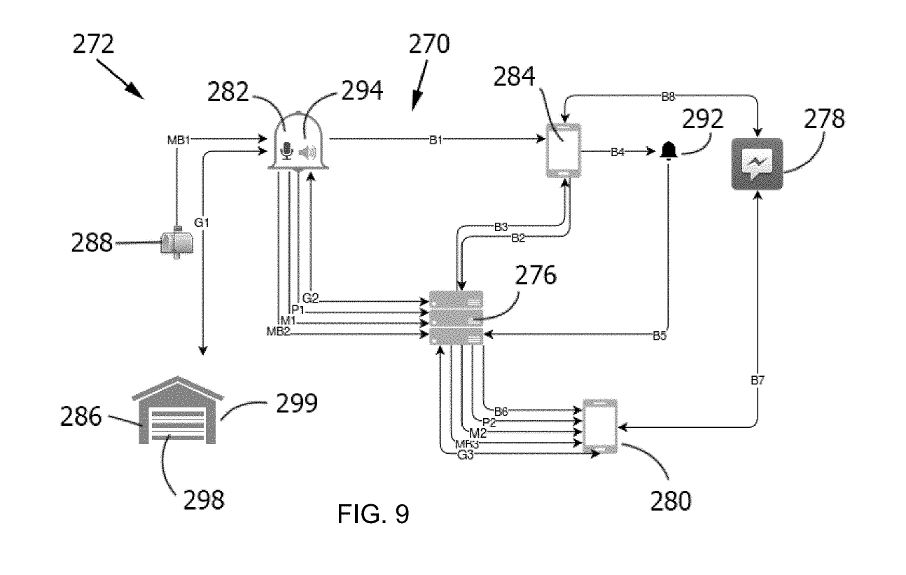

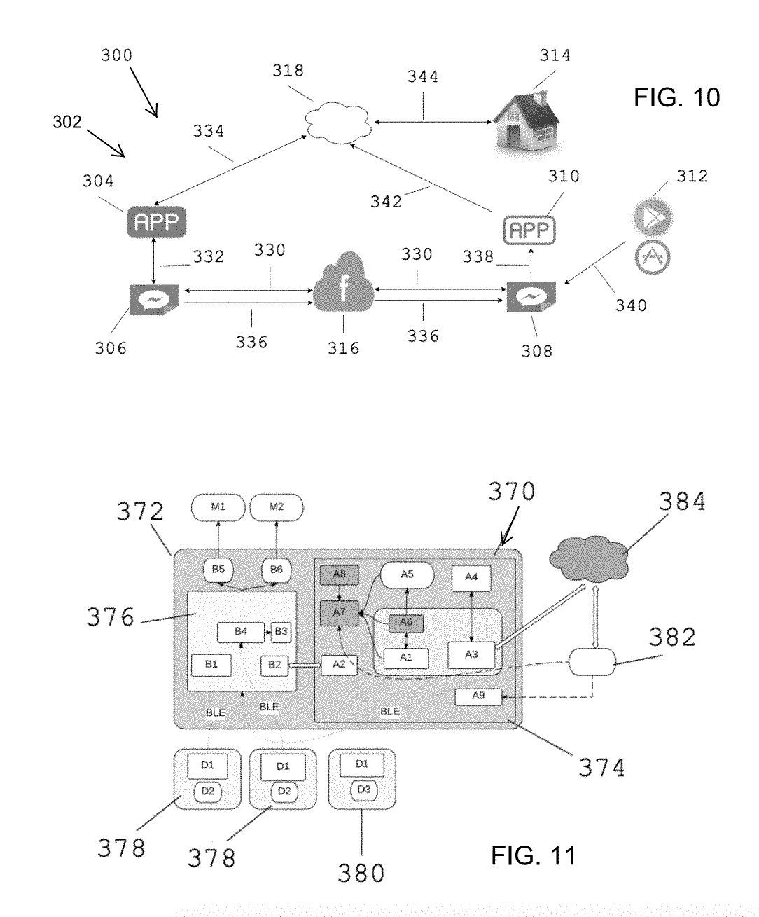

The present disclosure is further usable with mail boxes, door bells, and garage door openers, which can be considered smart devices, to name a few exemplary applications. For a door bell application and as further discussed below, the present concept can replace or supplement the traditional door bell, typically at or near the front door of a house or residence. In an example, a smart doorbell of the present disclosure is connected to the same VAC wires of the existing doorbell, which is typically 20 VAC. The present smart doorbell can support different configurations, such as optional mailbox and/or garage door monitoring and/or detection as accessories that can be electronically consolidated with the smart doorbell, as further discussed below. Optionally, the smart doorbell can even be installed inside the home, inside the front door, and a visitor can use a digital bell button to communicate. For example, for doors that do not have nearby power wires in the wall to power the Smart DoorBell, the SmartDoorBell can be plugged into a DC power adapter inside the home near the door or be provided with battery power. When the visitor approaches the door, Beacon signal from Smart DoorBell located inside launches an app on the visitor's phone to display a virtual bell button. The visitor can click on this virtual bell to send a push-notification to the owner's phone. The owner can then connect the visitor via Facebook Messenger to further identify the visitor before sending him a digital eKey for accessing the home, as described with reference to FIGS. 9 and 10.

The smart doorbell can also operate with or without Wifi internet access. In this latter case (without Wifi), the system's BLE-Beacon, such as the doorbell's Beacon chip, wakes up the visitor's phone app and uses the internet connection on the visitor's phone, which is running an associated phone App, to notify the home owner.

The smart doorbell can take advantage of a range of popular standards, apps/tools, and the smartphone' s chat/audio/video capabilities, such as the ability to advertise BLE-Beacon signals, access the FaceBook ID, and access the Facebook Messenger chat via the smartphone. The smart doorbell is usable with Wifi or without Wifi, as further discussed below. This smart doorbell concept can offer new and unique capabilities not presently available with traditional doorbells and can readily replace traditional doorbells at reduced costs compared to attempting to incorporate similar functions into existing doorbells, but yielding a product with not as many capabilities. Depending on the configurations of the smart doorbell, different features can be supported.

In an exemplary application of the smart doorbell of the present disclosure, a homeowner's smartphone receives notifications when a visitor approaches the front door of the homeowner's home. The homeowner's smartphone can detect the presence of the visitor using passive infrared sensor (PIR), motion sensor, built into the smart doorbell. Optionally, the PIR is only activated when the visitor rings the doorbell. The homeowner can then choose to automatically connect to the visitor via the visitor's smartphone using any number of Apps, such as Facebook Messenger app or a Doorbell App, so that the visitor's ID can be verified before the homeowner decides whether to open the front door. This identification process to ID the visitor can be implemented via chat, voice or photo image captured by the visitor's smartphone or even via the phone's video camera. Thus, the various capabilities of the smart doorbell of the present disclosure can be implemented using existing built-in capabilities, such as various capabilities or functions of the visitor's smartphone. By using existing capabilities, the present system can be implemented at lower costs than to acquire all new components and devices to install a smart doorbell system to any home or enclosed environment. For example, a built-in CMOS video camera is not required to be part of the smart doorbell but an image can still be viewed by the homeowner, nonetheless, using the built-in camera of the visitor's smartphone. Once the visitor's ID can be verified, the homeowner can optionally open the front door to greet the visitor or provide a message only to the visitor. Aspects of the smart doorbell are further discussed below with reference to FIGS. 9 and 10.

In a further example, an optional garage door system or a smart door lock application program interface (API) system can be integrated with the smart doorbell system. With the optional garage door opener that can be turned into a smart garage door opener and/or a third-party smart doorlock API system, the home owner can issue a temporary access key, which may be referred to as a digital eKey, and send the eKey to the visitor over the Internet. In an example, the eKey may be sent through one of different chat tools, such as a proprietary chat service or any other publicly available chat services, or optionally using the platform provided by the popular FaceBook-Messenger chat via its “Getsapp for Messenger” tool, as further discussed with reference to FIG. 10.

Based on the same high security “FB-Messenger Payment Services,” which enables a person to pay cash to friends via the messaging App, this scheme of sending an eKey through similar means allows the visitor to open the owner's garage or doorlock with the temporary digital eKey. Further, the eKey can readily change to a different password or code and the change can be performed remotely, unlike existing devices that allow access through the garage exterior keypad. The smart doorbell of the present disclosure can find useful applications in rental situations, such as renting under the AirBnB program, when renting cabins, or other access-type situations, such as after-hour access to a business complex. As another example, real-estate listings and buyers' agents can share access of the listed homes to potential buyers and viewers using the eKeys of the present disclosure. As yet another example, USPS, FedEx or UPS delivery personnel can gain access to the garage or a secured storage location using the eKey concept of the present disclosure to drop off shipped packages while the homeowner is away from home.

Foreseeably, a secured private drop box at a residence or business complex can be provided with a smart door opener technology of the present disclosure for receiving mail and/or delivery packages without allowing access to the delivery personnel to the entire garage. An eKey can quickly be sent to a FedEx or UPS delivery personnel upon verification of the personnel's ID. The personnel can then open the secured private drop box using the eKey that he receives over the Internet to deliver the package and then subsequently close the door or gate to the secured private drop box. The secured private drop box can embody any number of structures located externally of or built into a side of a house or building and provided with a smart doorlock that can be opened with an eKey. The smart door lock can be implemented using third-party smart doorlock API system. With the rise of internet shopping, the secured private drop box can reduce the frequency of mail thefts that are often reported on the news.

In an example, the system's built-in advertising Beacon signal or from yet another mechanism called “QR code scanning”, which will be discussed in a separate section further below, can wake up the visitor's phone to display a virtual doorbell, which when clicked or pressed, can start the following three services: push-notification to the owner's phone, chat service between the homeowner and the visitor, and the transfer of a secured eKey from the owner to the visitor to share access to a locked entry. As used herein, a homeowner implies any individual having supervisory control over the smart doorbell system of the present disclosure, which is typically a homeowner or his family members.

The present system can be used in a home that does not have WiFi connection, thus notification cannot be sent to the homeowner automatically. The present smart doorbell system can also be used in a home that chooses to place the Beacon doorbell inside the front door or where no bell button is accessible to the visitor, which may occur due to no available external power wires that bring the 20 VAC supply necessary to power the external doorbell.

Yet another configuration of the smart doorbell is an optional built-in speaker and microphone, together with voice-recognition services, such as Amazon Alexa AVS, or Apple Homekit Siri. These additional options enable new features, such as personalized or private greeting messages, to be sent to the visitor or for recording messages from the visitor to be sent to the owner.

An optional Beacon-based mailbox can also be supported to notify when a mailman has made a delivery. A switch in a mailbox can activate the BLE circuit when the mailbox is opened. Acting as a monitoring device, the smart doorbell's BLE scans for the mailbox' Beacon signal and reports this mailbox open event to the homeowner via push notification.

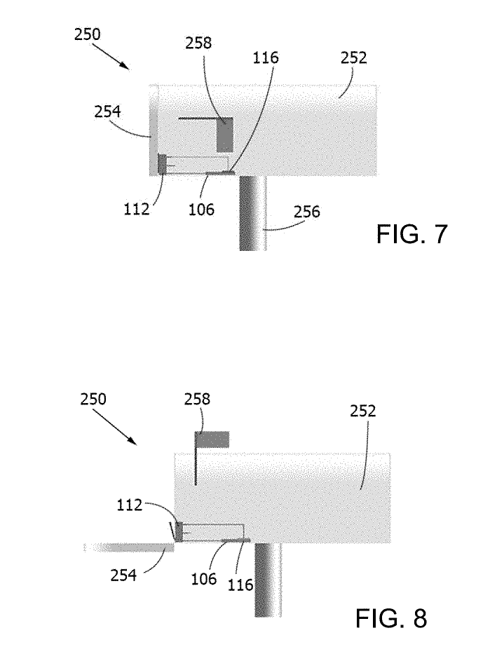

With reference now to FIG. 7, a mail box 250 comprising a box 252 and a door 254, which is closed against the opening of the box 252 in the closed box position, is shown. The mail box 250 is located or mounted on a support structure 256, such as a post, and has a mailbox flag 258 for use to indicate mail pickup. The mail box 250 can be equipped with a switch 112 and a BLE PCB 106 with a battery or power source 116 for energizing the PCB. The switch 112 can embody a button type that opens or disconnects when pressed by the door 254 between the door and the box 252. The switch 112 can close when the constraint of the door 254 is removed, such as when the door is swung open. In the mail box closed position of FIG. 7, power is disconnected from the BLE PCB 106. Optionally, other switch types can be used to control power to the BLE PCB 106.

FIG. 8 shows the mail box 250 of FIG. 7 in the mailbox open position, wherein the door 254 is hingedly swung away from the opening of the box 252. When the door 254 is swung opened, the switch 112 is activated to energize the BLE PCB 106. This then allows the BLE PCB 106 to start emitting or advertising Beacon signals. The advertised Beacon signals can be detected by the smart doorbell of the present disclosure which can then communicate with the owner, such as through a gateway or a smartphone 170, as previously described, or directly if WiFi is available. The information can also be sent to a Cloud-based server to track and trend information, if desired and as further discussed below. The smart mailbox can be registered with the Cloud server upon installation of the BLE PCB 106 so that information about the smart mailbox can be monitored and/or tracked upon the opening and closing thereof. The smart mailbox ID and information related to the home, such as the homeowner ID, can be registered with the Cloud server. When a button is used with the PCB on the smart mailbox, it can allow a mail delivery person to ring the doorbell, as an example, by pushing the button to notify the homeowner that he has mail. The activation of the button can cause the BLE PCB of the mailbox to alert the smart doorbell, which can then trigger the audible doorbell or send a message to the homeowner's smartphone.

With reference now to FIG. 9, a process flow diagram 270 is shown depicting a system 272 of the present smart doorbell, smart garage door opener, and smart mail box of the present disclosure. The system 232 can include the following hardware components: a Cloud server 276; an App 278 for verification and transferring information, such as a Facebook Messenger app; a home owner's smartphone 280; a smart doorbell 282 at the front door of the owner's house with optional built-in PIR motion sensor and bell button; a guest's smartphone 284; a smart garage door opener 286; and a smart mailbox 288. In an example, the smart garage door opener, the smart mailbox, or both can be omitted.

The smart doorbell 282 of the present disclosure can be sized and shaped to fit over or with the location of most if not all existing doorbells and be powered by the existing electrical system. The smart doorbell 282 is fitted with a BLE PCB and a WiFi communications module. The smart doorbell 282 can also be fitted with a PIR motion sensor for sensing an approaching visitor or guest, which can then initiate the onboard circuits to perform different tasks, as further discussed below. Upon installation of the smart doorbell and like the smart mailbox, the homeowner can register the smart doorbell with the Cloud server of the present system, which can include the doorbell ID and information related to the home, such as the homeowner ID.

With the smart doorbell 282 of the present disclosure installed at or near the exterior front door of a house, when a visitor or guest with a smartphone 284 approaches the smart doorbell 282, his motion as detected by the PIR sensor or his ringing of the doorbell button can wake up an App in the guest's smartphone 284. In an example, the App in the guest's smartphone 284 can be a Doorbell App so that the visitor's ID can be verified by the homeowner. In an example, the PIR motion sensor detects the approaching visitor and wakes up the BLE PCB to emit a Beacon signal, which in turn wakes up the Doorbell App, previously loaded, in the guest's smartphone 284. The App receives the ID of the Smart doorbell 282 via the Beacon message generated by the smart doorbell. This is represented as step B1 in the process flow diagram of FIG. 9.

The App in the guest's smartphone 284 then forwards the ID of the smart doorbell 282 and the guest's ID to the Cloud server 276. The guest's ID, such as his Facebook ID or other form of identification, can be registered on the Cloud server when the guest first downloads or installs the doorbell App. This is represented as step B2 in the process flow diagram of FIG. 9. For a home with Wifi connectivity, the built-in Wifi module in the smart doorbell 282 supports an alternative method for notifying the cloud server 276 of the visitor's motion or doorbell push event instead of paths B1 and B2, which rely on the guest's cellular phone for the Internet connection. Where Wifi is available, the smart doorbell can communicate, via step M1 in FIG. 9, with the cloud server 276 directly regarding the detected events. Step M1 is discussed further below. Thus, the present system is understood to be usable in a home or other enclosed environment with or without Wifi connectivity.

The Cloud server 276 checks the ID of the smart doorbell 282 and checks the Cloud server database for information related to this smart doorbell ID. The Cloud server then returns the ID of the homeowner's phone 280 along with the name of the smart doorbell 282. The name of the smart doorbell 282 can be any name and can be in alpha-numeric, such as the homeowner's name, the homeowner's telephone number, etc. The guest's smartphone 284, running the DoorBell App, then displays a virtual bell button 292 and the name or ID of the smart doorbell 282. These steps represent the initial verification procedure of the present disclosure and can occur even before the guest knocks on the door or press any bell button, such as when initiated by the motion sensor detecting movement. The process can also occur relatively quickly, in the order of a few seconds.

After being presented with the virtual bell button 292, the guest can press the virtual button to initiate the next step. This is represented as step B4 in the process flow diagram of FIG. 9.

The act of pressing the virtual button 292 instructs the guest's smart phone 284 to send the homeowner's phone ID, which the guest's smartphone has received at step B3, to the Cloud server 276 for further authentication. This is represented as step B5 in the process flow diagram of FIG. 9. In an example, the App running on the guest's smartphone receives the click of the virtual button as affirmation to proceed to the next procedure of the verification protocol, as further discussed below.

Upon receipt of the message from the guest's smartphone by the Cloud server 276, the Cloud server is programmed to verify whether the message from the guest's smartphone is spam or from an unrecognized source by verifying the guest's ID. If the message is legitimate, the Cloud server 276 sends the guest's Facebook (FB) ID to the homeowner, to the homeowner's smartphone, tablet, or other devices that the homeowner may choose to manage the system 272. This is represented as step B6 in the process flow diagram of FIG. 9. In some examples, a different ID system is used for authenticating other than the Facebook ID. For example, a LinkedIn ID or other future popular social connectivity sites and IDs related to those sites can be used.

Once the homeowner's smartphone receives the guest's FB ID, the homeowner can select to chat with the guest via some available chat tools, such as Facebook Messenger. This is represented as steps B7 and B8 in the process flow diagram of FIG. 9. If the guest and the homeowner already know one another, the chat can be a simple hello or a quick note about the visit. If the guest is not known to the homeowner, such as being a salesman or a technician making a house call to service an appliance, as an example, the homeowner can further evaluate whether to let the guest in. In still other examples, the App running on the guest's smartphone and the App running on the homeowner's smartphone can open the video function of each phone to enable the two individuals to see one another and chat prior to the homeowner deciding on whether to let the guest in. The video function can use FB-messenger, FaceTime, Skype, or other video Apps to chat by video.

In an example, a motion detector 294, such as a PIR motion sensor, is incorporated with the smart doorbell 282. When incorporated, motion detected by the motion detector 294 can be treated as a motion detected event and the event can be sent, via the built-in Wifi in the smart doorbell, to the Cloud server 276 to notify the homeowner of the event. This process is represented as step M1 in the process flow diagram of FIG. 9.

Similar to the motion detected event, when the guest presses the smart doorbell 282 button, this doorbell button press event is sent to the Cloud sever 276 via the home Wifi network. This process is represented as step P1 in the process flow diagram of FIG. 9. Alternatively, as discussed above, the motion detected and bell pressed events can activate the Beacon module in the smart doorbell that then sends the information regarding the events to the Cloud server 276 via the guest's smartphone, via steps B1 and B2, or via a dedicated gateway with Wifi, as further discussed below.

In an example, the Cloud server 276 can be programmed to send the motion detected event and the doorbell activated event, via push notification messages, to the homeowner's smartphone 280. These steps are represented as steps M2 and P2 in the process flow diagram of FIG. 9 and can work the same way for both cases described above: using a home Wifi network or using a guest's cellular phone triggered by the doorbell's Beacon signal.

In yet another example, a smart mailbox 288 is incorporated with the system 272 of the present disclosure, which is optional and can be omitted. Aspects of a smart mailbox are previously discussed with reference to FIGS. 7 and 8 and reference to the smart mailbox 288 of FIG. 9 can be understood to encompass the same or similar smart mailbox. When incorporated with the smart doorbell 282 of the present disclosure and upon a state change, such as the door of the mailbox being opened or closed, the smart mailbox 288 advertises its Beacon or iBeacon, which can be detected by the smart doorbell 282. This process is represented as step MB1 in the process flow diagram of FIG. 9.

After detecting the Beacon of the smart mailbox 288, the smart doorbell 282 of the present system 272 sends a mailbox state change event to the Cloud server 276 to record the event and send notification to homeowner. This process is represented as step MB2 in the process flow diagram of FIG. 9. The Cloud server 276 can be programmed to verify or check the mailbox settings to determine whether the event is expected or authorized. For example, the homeowner can log into the Cloud server and using the web-browser dashboard to input information or instructions regarding the smart mailbox. Thus, if no special delivery is expected and the mailman only delivers mails once a day, two or more mailbox state change events recorded by the Cloud server 276 can be flagged as abnormal. This information allows the homeowner to further evaluate whether to take any additional measures, such as to install a lock or a security camera. The check settings step is represented as step MB3 in the process flow diagram of FIG. 9.

In an example, an optional tilt-sensor 298 in a tilt sensor module, discussed further with reference to FIG. 11, is attached to a panel of a garage door and usable with a smart garage door opener 286 and can be incorporated with the system 272 of the present disclosure. Upon installation of the smart garage door opener and the tilt sensor module, and like the smart mailbox and other smart devices discussed herein, the homeowner can register the smart garage door opener and tilt sensor module with the Cloud server of the present system, which can include the garage door opener ID, tilt sensor ID, and information related to the home, such as the homeowner ID. The smart garage door opener 286 with a BLE-based opener-relay board is optional and can be incorporated with the smart doorbell. When incorporated and when the tilt-sensor 298 on the panel of the garage door changes state, such as when the garage door is opened or closed, the Beacon incorporated with the tilt-sensor module, which can have both a tilt sensor and a BLE circuit, activates and is then detected by the smart doorbell 282. This process is represented as step G1 in the process flow diagram of FIG. 9. Via its built-in Wifi, the smart doorbell 282 of the present system 272 then sends a garage door's tilt-sensor state change event to the Cloud server 276 to record the event and by push notification notifies the homeowner. This process is represented as step G2 in the process flow diagram of FIG. 9.

After being notified of the door state, the homeowner can optionally open or close the garage door by activating the garage door motor via a BLE-based opener-relay board 299 that can be activated over Bluetooth BLE by the Smart doorbell 282 and further discussed below with reference to FIG. 11. This process is represented as step G3 in the process flow diagram of FIG. 9, which can comprise the following steps: the homeowner's phone 280 sends an open or a close command to the cloud server 276 which then forwards this command to the Smart doorbell 282 via its built-in Wifi. The Smart doorbell then forwards this open/close command to the opener relay board 299 connected to the garage door opener thereby making it a smart garage door opener. Optionally, the smart garage door opener can receive the command directly from the Cloud server with its built-in Wifi module and then directing the opener relay board to open or close the garage door, by activating the garage door opener motor. To extend the range of communication of the BLE signal, a Mesh network protocol can be incorporated to allow range extension between the smart doorbell and the garage motor box location.

Next, the process of identifying the visitor and sharing a digital access key (eKey) is described. The process can include the use of a chat tool. In a particular example, the FB-Messenger Getsapp for Messenger scheme can be used to create and share an eKey for opening a lock, activate a switch, or activate a motor. The FB-Messenger Getsapp for Messenger is a tool in the FB Messenger Platform that allows program developers to add or integrate their own Apps into the Messenger Platform. With Messenger Platform, an app's content as created by a developer, such as a DoorBell App, a Garage App, or other Apps discussed elsewhere herein, can be shared by users of Messenger. The Apps can be built for iOS or Android and once completed can be shipped to the Apple App Store or Google Play for download by users.

The present FB-Messenger Getsapp for Messenger scheme for sharing the eKey leverages similar tool/infrastructure used in the FB-messenger Pay services that allow FB friends to send money securely to each other. The pay services scheme allows the transfers of payments without the user having to open a different App, such as PayPal. Instead of sending payments, this scheme can be used to securely and remotely allow a visitor access to a home's garage and/or front door by sending an eKey that can be used to activate a lock, opener or other electronic devices, as further discussed below.

With reference now to FIG. 10, a process flow diagram 300 of a digital eKey transfer involving a FB-Messenger Getsapp for Messenger or otherwise known as FB Messenger Platform scheme is shown. The scheme using the Messenger Platform may be utilized to create and send an access key to a visitor, a renter, or other individuals. This individual, who is already connected to the owner via the smart doorbell's Beacon or the home Wifi described earlier in FIG. 9, can also be connected in a broader, more general application of lost and found, emergency, or tracking situations or applications as described below.

The digital key transfer scheme can also be used to deliver to a user that has scanned a quick response (QR) code via a sticker or on other mediums attached to a lost/stolen item, such as a luggage, a bike, a laptop, a car, a book, etc., or to any item that the registrant of the QR code wishes to track or monitor. By scanning the QR code sticker, the profile of the registrant of the code can be accessed by the individual. This allows the individual to read the contact information of the owner of the lost/stolen item or object to be tracked associated with the QR code, send a notification to the owner, chat with the owner, and then receive an eKey to perform other steps, such as to open a padlock on the object found, be provided with a coupon or other credits as a reward for finding and returning/shipping the lost/stolen item to an address to be provided, etc. This QR code capability of the present system is further discussed below.

The system 302 for transferring an eKey can include the following components: a Garage App 304 on a homeowner's smartphone; a Facebook messenger App 306 on the homeowner's smartphone; a Facebook messenger App 308 on a visitor's smartphone; a Visitor's AccessKey App 310 on the visitor's smartphone; an Apple appstore or Android appstore for downloading the “Visitor's AccessKey app” 312; a smart Garage door opener and/or a smart Door Lock opener 314; the Facebook Messenger server 316; and a Cloud server 318 running software for maintaining and controlling the garage door/eKey system.

As further discussed below, the Garage App 304 is configured for controlling the garage door/door lock of the homeowner's house and can be used to set up access levels/schedule, etc. for visitors. The visitor's AccessKey App 310 can be used by a visitor to receive a temporary digital AccessKey, such as an eKey, for temporary access (e.g., a week long for an AirBnB renter) or for a one-time access (e.g., for the Delivery person from FedEx, Uber-home meal delivery service, etc.) to a garage door, a door lock, or a secured structure having a smart doorlock.

FIG. 10 depicts an exemplary process or method 300 for interacting between the homeowner's and the Visitor's apps to enable the Visitor to receive an Access Key, such as a digital key or eKey. In an example, the process of FIG. 10 can provide means for the homeowner to chat with the visitor to identify the visitor's ID before deciding on the visitor's access level. For example, by first verifying the visitor's ID, the owner can then decide to give the visitor access only or also door-status monitoring capability, or access only during certain permissible time periods when other individuals are present. The visitor can also be given access pursuant to a schedule, such as on Mondays and Fridays, between 10 AM and Noon, for housekeeping. This process is represented as step 330 in the process flow diagram of FIG. 10. The communication can also be done through the Facebook Messenger 316 service.

If the homeowner is satisfied with or recognizes the visitor's ID, the homeowner can switch from the FB-messenger app 306 to the Garage App 304 on his smartphone to create an Access Key, such as an eKey, for the visitor. This switching between apps is supported by the Getsapp for Messenger or Messenger Platform scheme inside the Facebook messenger App. This process is represented as step 332 in the process flow diagram of FIG. 10.

The Owner's Garage App 304 can then request an Access Key from the Cloud server 318 to provide to the visitor. To create the eKey, the Owner's Garage App 304 communicates with the Cloud server 318 to specify the following exemplary eKey parameters: which door to access, which level/schedule for the access. This process is represented as step 334 in the process flow diagram of FIG. 10.

Once the owner's Garage App 304 receives the eKey from the Cloud server 318, it switches to the FB-messenger App 306 via “Messenger Sharing scheme” to send the Access Key to the visitor's Facebook Messenger App 308. This process is represented as step 336 in the process flow diagram of FIG. 10.

The visitor then receives a message about the eKey in the visitor's Facebook messenger App 308. Upon receiving and clicking on the Access Key in the visitor FB-messenger App 308, using Getsapp for Messenger scheme in the Facebook messenger app, the visitor can be prompted to take either one of the following two steps: the visitor can be prompted to Install the “Visitor AccessKey app” 310 from the Appstore 312, if this App was not previously installed in the visitor's smartphone. This process is represented as step 340 in the process flow diagram of FIG. 10. If the App was previously installed in the visitor's smartphone, the visitor can be prompted to open the “Visitor AccessKey app” 310. This process is represented as step 338 in the process flow diagram of FIG. 10.

The “Visitor AccessKey app” 310 is then used to check if the Access Key was stored in the Cloud server 318 with authorized access rights, as provided by the homeowner and discussed above. This process is represented as step 342 in the process flow diagram of FIG. 10. Once the Access Key has been found to be valid, control commands like Door Close/Door Open can be displayed on the user interface (UI) of the user's smartphone for the visitor to select and send to the Cloud server 318 to control the door connected to the smart Garage door opener-relay or smart Door Lock 314, such as on the front door. This process is represented as step 344 in the process flow diagram of FIG. 10.

In an example, the system in accordance with aspects of the present disclosure can integrate the architecture of a Garage-Door Opener and the Access Key feature or architecture of FIG. 10 with the BLE-based doorbell accessory of FIG. 9 to form an integrated home access management system of platform.

FIG. 11 depicts a system 370 with an alternative architecture of a garage door opener with BLE-based doorbell accessory, such as a smart garage door opener/tilt sensor and a smart doorbell. The Apple Homekit-based remote controllable garage door opener architecture of FIG. 11 can be used together with the Access Key feature of FIG. 10 and the smart doorbell scheme of FIG. 9 to form an integrated home access management system.

In an example, the garage door opener system 370 of the present embodiment comprises a gateway board 372 configured to connect to the Cloud server 384 to report the status of the tilt sensor 378, the status of the smart doorbell 380, and to receive user's commands from a smartphone 382 to open/close the garage door's motor or motors M1, M2. The gateway board 372 can include a Wifi module with a central processing unit (CPU) 374 and a BLE module with a microcontroller (MCU) 376. The gateway board 372 can be housed in a box with appropriate I/O connections to the existing garage door opener to convert the garage door opener into a smart garage door or smart garage door opener. Alternatively, the mother board or controller on an existing garage door opener can be expanded to include the gateway board 372 of the present disclosure.

One or more BLE tilt modules 378 having tilt sensors D2 can be used with the system of the present disclosure. The one or more tilt modules 378 can be attached to the garage door, such as to a surface of a folding garage door panel, for monitoring the door status. As the panels move from an open position to a closed position or vice-versa, their orientations will change, resulting in different tilt angles: horizontal or vertical. These 2 different tilt angles can be detected by the tilt modules 378, which can then interact with the garage gateway board 372 to record, send alert, etc., as further discussed below.

A smart doorbell 380 can be integrated, via BLE or BLE mesh network to extend the range between BLE enabled devices, such as between the smart doorbell and the garage door opener system 370 of the present disclosure. The smart doorbell 380 of the present embodiment can have features as described above with the reference to the smart doorbell 282 of FIG. 9.

The system 370 is further usable with one or more smart phones 382 (only one shown). Smartphones 382 usable with the present system should be WiFi capable and optionally includes BLE capability.

The system 370 can be configured for use with a Cloud server 384 and one or more garage motors M1, M2 for opening or closing one or more garage doors. The Cloud server 370 can provide the user with remote access to the system 370 from anywhere with an Internet connection and allows the system to take advantage of other web-based programs and functions, as further discussed below.

In an example, the WiFi module with CPU 374 runs a hypertext transfer protocol (HTTP) server A1 to provide an interface for configuring different door functions. For example, this HTTP server supports functions such as adding, removing, and configuring of door options, such as for scheduling periods when the doors cannot be accessed. An Apple HomeKit protocol A7 (FIG. 11) can be incorporated with the Wifi-CPU module 374 to discover, connect, and interact with other Homekit-compatible home appliances, as further discussed below.

The WiFi module with CPU 374 can further include a universal asynchronous receiver/transmitter (UART) module A2 for communicating with the BLE module 376, and a simple HTTP client server A3 for supporting “POST, GET” methods and for communicating with the Cloud server 384 via WiFi.

For security purposes, the WiFi module with CPU 374 can include an encryption/decryption module A4 so that all messages coming in/out to/from the gateway board 372 can be decrypted/encrypted with user secret code using hash and dynamic key sharing as provided pursuant to the Advanced Encryption Standard (AES).

The WiFi module with CPU 374 can include a smart configuration module A5 for Wifi configuration and over the air (OTA) firmware update module A9, via both smartphone and cloud server. Additionally, to support Apple Homekit standard, the following modules are also supported: WAC module A5, Bonjour/mDNS discovery module A6, Homekit Core module A7, MFI coprocessor A8 for HomeKit Authorization. These modules can be incorporated to support the Appel Homekit protocols.

The BLE module 376 in accordance with aspects of the present disclosure includes a BLE mesh protocol B1 for use with a BLE mesh network, via BLE Repeater nodes. The BLE Mesh protocol B1 allows the gateway 372 to monitor remote BLE sensors (such as the BLE signals in the smart doorbell and the Smart mailbox) well beyond the typical BLE range of about 70 feet. A fuller description of a BLE-Mesh networking architecture is discussed can be found in regular application Ser. No. 14/836,955, filed Aug. 26, 2015 and in co-pending application entitled A SMART HOME PLATFORM WITH DATA ANALYTICS FOR MONITORING AND RELATED METHODS, filed Feb. 16, 2016, bearing Attorney Docket No. 1373-009.401, the contents of each of which are expressly incorporated herein by reference as if set forth in full. The BLE-Mesh network allows various BLE beacon devices, repeaters, and gateways to interconnect. This allows for signals and/or commands to transfer from a sending node to a target node either directly or indirectly by passing through other nodes.

The BLE module 376 can further include a universal asynchronous receiver/transmitter (UART) module B2 for communicating with the Wifi module 374 and an over the air (OTA) module B3 for upgrading BLE firmware via smartphone.

The BLE module 376 can also include a BLE central mode B4 and one or more relay modules B5, B6 for controlling a first garage door and a second garage door. Optionally, the relay modules can be expanded to operate in a parking structure with more than two garage doors. The BLE central mode B4 is configured for scanning and receiving BLE signals or messages from nearby BLE-based sensors. The first relay module B5 can control the first garage door and can be wired to the first motor M1. The second relay module B6 can control the second garage door and can be wired to the second motor M2.

The one or more tilt modules 378 previously alluded to can each include a BLE module D1 for monitoring the status of one or more doors, and for reporting to the gateway 372 via encrypted BLE message. Each garage door can have one or more tilt sensor modules mounted on the multiple door panels but typically one tilt sensor module per garage door can suffice. In some examples, the sensors can comprise an accelerometer or a PIR sensor to monitor motion via passive infrared.

The smart doorbell 380, which can be similar to the smart doorbell discussed elsewhere herein, can include a PIR motion sensor D3 to detect the presence of a visitor or the visitor pressing the doorbell, as previously discussed. The smart doorbell 380 can also include a BLE chip or module D1 to advertise these events using encrypted beacon signal to communicate or send to the gateway 372 over BLE or BLE mesh network. The gateway 372 can then relays these events over Wifi to the cloud server 384, which notifies the homeowner via push notifications to his phone. Thus, when the gateway 372 is used in an integrated Home Access management system, which has built-in Wifi, the smart doorbell can optionally not incorporate any Wifi module. In the present embodiment, the smart doorbell 380 can optionally exclude any built-in Wifi module and instead communicate with the gateway through BLE.

When use with a smartphone 382, such as the homeowner's smartphone, the system 370 will allow the homeowner to support remote home access management functions, such as to control the authorization level of who gets which eKey to access which controllable devices, locks, or motors, such as the motor on the garage door opener to open the garage door. The eKey can be programmed to include a schedule, such as for which day and time period, and an expiration period, such as for 3 days or 1 week. All in/out messages through the smartphone 382 can be encrypted/decrypted for security protection. The smartphone 382 enables the system 370 to support various automatic modes and scheduling such as: “peace of mind” feature that auto-closes the door if the owner forgets and leaves the door open after certain programmable time length; or curfew schedule to deny entry after certain time at night; or notification to the homeowner's phone of any door state change, and optionally by who in the household. Further, when the Cloud or Wifi is temporarily down, via a BLE-enabled smartphone, the system 370 can still allow the user to open/close the garage door locally. This alternative access capability can be made possible via direct encrypted open/close commands from the phone to the gateway 372 over BLE.

The cloud server 384 can act as an interface bridge between smartphones (of the owner and guest(s)) and the gateway 372. The cloud server 384 can receive open/close commands from the smartphones and then trigger the gateway 372 to execute these commands by activating the relays on the garage door opener to open the garage door. The Cloud server 384 can also receive signals from the one or more tilt sensors attached to the garage door and from the smart doorbell via the gateway 372 and then send push-notifications to the users' smartphones regarding the status or events. Other BLE-based sensors around the house or enclosed space (e.g., mailbox, window being opened, etc.) can also be monitored via the same infrastructure, optionally with BLE Mesh network to improve the sensor monitoring range.

An exemplary process using the system of the present system 370 to remotely open/close the garage door includes the following steps: using Wifi or 3G/LTE on a smartphone 382, the user sends a command to the cloud server 384. The request is then sent from the cloud server 384 to the home's cable/DSL modem and Wifi router, and then to the Wifi module 374 of the gateway 372. This message is then passed to the BLE module 376 for controlling the one or more door motors M1, M2.

The open or closed state of the garage door(s) can be monitored by the one or more tilt modules 378, each of which comprises a BLE chip D1 and a tilt sensor D2. The BLE chip D1 is configured to report the status of the tilt sensor to the BLE module 376 on the garage gateway 372 via an encrypted advertising message. The status is then sent to the cloud server 384 by the Wifi module 374. The state of the garage door sent by the garage gateway 372 can be stored on the cloud server 384. The cloud server 384 can be configured to report and notify the smartphone 382 belonging to the user, such as the owner, about the status of the garage door. The cloud server 384 can also be configured to process some “if this then that” (IFTTT) commands, such as to auto close if the garage door is left open for longer than a specified duration.

Yet another use case of the system 370 in FIG. 11, when combined with FB Messenger-based eKey sharing in FIG. 10, can offer an Integrated Home Access Management platform that seamlessly supports at least some or all of following features: notifies the home owner when there is a visitor at the door, allows chatting with a visitor for identification purposes, and allows sharing of digital keys, such as an eKey, to let the visitor access the home or other controllable structures, such as the garage, via the visitor's phone. When the PIR sensor D3 on the Smart doorbell 380 is activated by the visitor's motion or the bell button is pushed by the visitor, the BLE chip D1 in the smart doorbell can send an encrypted Beacon message to the BLE module 376 of the garage gateway 372. This event can then be reported by the garage gateway to the cloud server 384, which can then notify the homeowner's smartphone 382. The homeowner can then use the FB messenger-based eKey sharing scheme of FIG. 10 to chat and identify the ID of the visitor before sending him an eKey to control the door or activate other devices as described in FIG. 11.

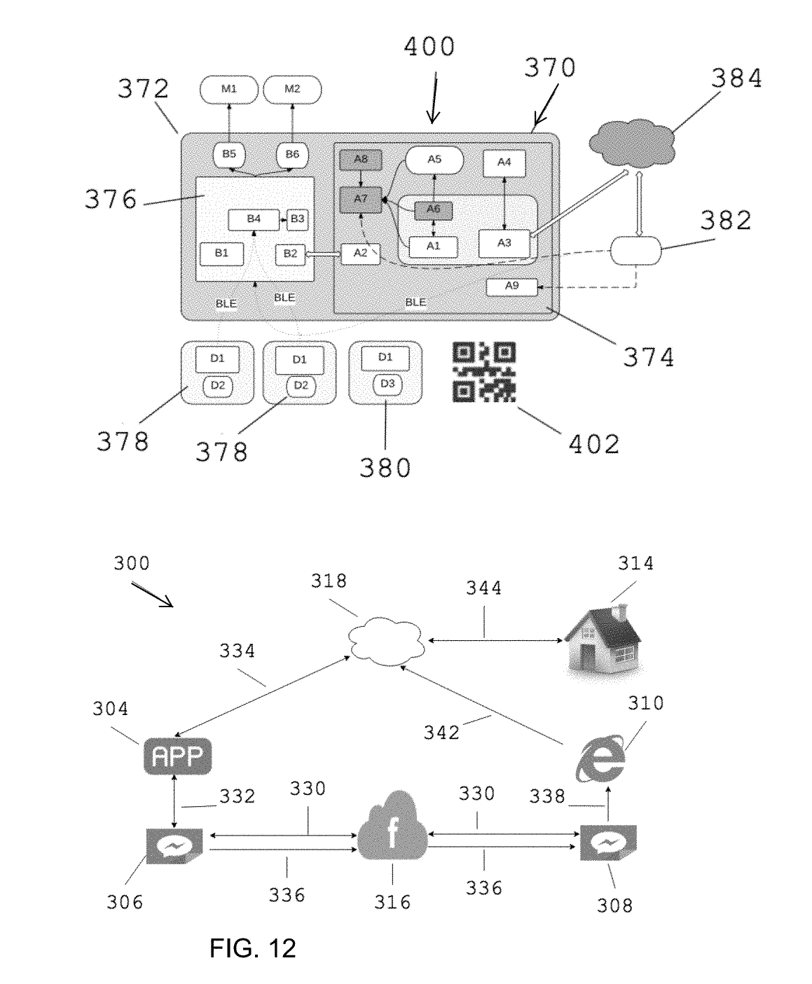

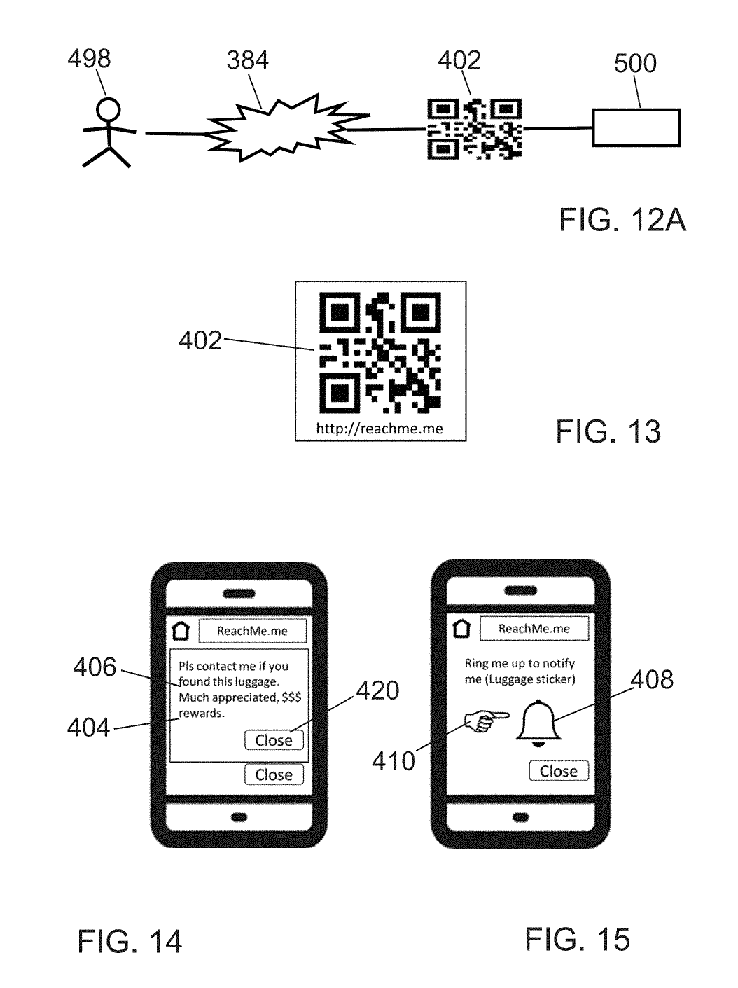

In an alternative embodiment, different actions or functionalities discussed elsewhere herein can seamlessly be supported in an integrated access platform shown in FIG. 12. The system of FIG. 12 can be considered a system for facilitating communication between two or more parties using QR codes. In this embodiment, an initiation scheme resembling that of FIG. 11 and a scheme for transferring a digital key resembling that of FIG. 10 are used in combination to achieve an integrated access platform or system 400. Whereas a Beacon advertising message triggered by a doorbell button or a PIR motion sensor on a smart doorbell 380 can be used to notify a phone of another, such as a homeowner's phone 382 as discussed above, in the present embodiment a quick response (QR) code can be used to notify the phone 382. Optionally, both the QR code and the Beacon advertising message can be used in the same system by a user or users to notify the phone 382 of another. Further, the integrated access platform shown in FIG. 12 can use the same Cloud server and therefore the sub-systems 370, 300 show the Cloud Server with element 384. Also, as the Application 310 shown in the sub-system 300 can be a web browser app.

For purposes of the present system, a first user refers to a person a QR code is associated with, which can be a homeowner, a registrant, or an individual who can be tracked by the QR code, and a second user refers to a person that scans the QR code to decode the information contained therein. With reference initially to the sub-system 370 for initiating contact of the integrated access platform 400, a second user, such as a visitor, a delivery person, or a Good Samaritan who wants to return a lost/found item or who wants to contact the first user triggers a notification to the first user's phone by first reading or scanning a QR code 402. The QR code 402 can be located at or near the front door of a home or on an object that is remote from the home, such as a lost luggage, a bike, a pet, a laptop, a child, etc. Similar to the ubiquitous 1-dimensional barcode, the QR code is considered 2-dimensional and is favored by many as a way to represent information in an image format. In the present embodiment, QR codes 402 can be used by the second user to notify the first user about an item or subject that the QR code is found on and allowing the first user, such as the owner or the registrant of the QR code, to perform follow up functions or options, such as to provide the second user of an eKey, a reward, a contact information, or a message.

In an example, the QR code image 402 can be generated by the first user by printing the QR code onto a small sticker or a different tangible medium, such as using 3D printing to print the QR code 402 on a thermoplastic badge or a collar to be worn or used to tie to another structure or object. The present QR code scheme can be referred to as a ReachMe scheme and can be implemented using web-browser app and a Cloud server database 384, as shown in FIG. 12A. The first user 498 can access a ReachMe web-browser app to register himself and then associate one or more QR codes with information that the first user wishes to associate. For example, the first user can link a QR code with information about the homeowner, about a lost child, about medicinal needs or conditions of an individual, about a lost pet, where to contact or visit to get additional information, emergency contact information, an email address, a phone number, a business name, a business contact information of the first user, etc., to name a few non-limiting examples. Each QR code generated can be indexed with an IndexID on the Cloud server database 384 associated with the ReachMe web-browser app. Because the present system can be implemented using a Cloud server, the first user can optionally access the Cloud server to edit the text or information linked or indexed with the particular QR code on the fly for different situations. For example, the first user can edit the information to include updated or different information for a specific purpose, which may be different from information provided a day before or shortly thereafter. The information can be specific for a particular guest (e.g., FedEx, DHL, or UBER driver) or situation (construction repair workers) and can change from different guests or situations. Thus, a particular guest can see immediately after scanning a QR code at the front door of the first user a message provided to him by the first user and a different guest can receive a different message when scanning the same QR code at a different time.

The generated QR code 402, which is now indexed with an Index ID, is then placed on or near a front door of a house, on an object, or on a subject 500 to be associated with the QR code, such as a luggage, a bike, a text book, a backpack, a laptop, a child, a car, a pet, etc. By using and placing the QR code 402 on an item 500 to be tracked or associated therewith, the first user can link his contact information or other information that he desires in code form for people, e.g., a second user, to use, such as to reach him. Another use of the QR code is at seminars or conferences to enable participants to scan and collect contact information of one another. A first attendee can wear a QR code and when scanned by a second attendee, and vice-versa, the information of the first attendee can be relayed to the second attendee.

Any first user or second user can visit the cloud server 384 to generate a QR code. For example, the first user can visit the URL www.reachme.me to run a web-browser app or can be re-directed from a website, text, chat, or email to a URL running a ReachMe web-browser app. Still alternatively, the sticker or medium bearing the QR code 402 can include a URL address that a first or a second user can then type to access the ReachMe web-browser app. The ReachMe App lets the first user generate a QR code 402 and associate information with the QR code, as discussed above, and lets the second user use his smartphone camera to scan the QR code 402. An exemplary QR code is shown in FIG. 13. Once the ReachMe web-browser App is up and running and by using the camera on the smartphone, the ReachMe app is programmed to decode the image into readable text 404 and presents the readable text to the second user, such as that shown in FIG. 14. The ReachMe app can further be programmed to provide the second user with additional options, such as an option for acting on the information provided by the readable text.

The readable text 404 may be referred to as a decoded text 406, which is understood to mean text that has been derived from a QR code captured by a QR reader, such as a camera. In an example, the ReachMe web-browser app queries the Cloud server database 384 associated with the captured or scanned image of the QR code 402 for the associated IndexID, which is linked to information previously entered by the first user. This queried information is then presented to the user in FIG. 14 as a decoded text 406. The decoded text 406 can include any number or types of information previously entered by the first user, e.g., the homeowner or the registrant, of the QR code 402. As shown in FIG. 14, the decoded text 406 specifies information about a lost luggage and a reward for the person that locates and contacts the first user regarding the QR code 402 and the item or thing that it is associated with. In other examples, the decoded text 406 can include other information.

The second user can then act on the decoded text 406 presented in FIG. 14. In an example, the user can tap the close 420 button to jump to another screen. Alternatively, the second user can be presented with links, buttons, and/or instructions to perform different available options or tasks. By pressing the close button 420, the user is then presented with a virtual doorbell 408 on his phone screen, as shown in FIG. 15. An optional message, icon, or clue 410, such as a pointing figure, can be included as implied instructions for the user to press the virtual doorbell 408. If press, a message or notification is then sent to the first user, such as the owner or registrant of the QR code.

After pressing the virtual doorbell, the second user, such as the scanner of the QR code, can then choose different options to communicate with the first user. Optionally, when the second user hits close 420 in FIG. 14, the user is immediately presented with specific options for contacting the first user. If the second user has logged into Facebook FB messenger app, then using this Messenger app to send notification would allow the first user to identify the ID of the second user via the second user's FB profile. Alternatively, the second user can use the proprietary ReachMe cloud server 384 to send the notification to the second user. In either case, the first user can be reached anonymously via notification to his smartphone, when the second user presses the virtual doorbell 408, without the second user having access to the first user's private contact information, such as the first user's name or telephone number, thus eliminating any privacy concern. Of course, if the first user, such as a homeowner or a registrant, wants to provide his personal contact information, he can do so by sharing this information when he creates the QR code 402 on the cloud server 384. For example, if the owner provides his personal contact information, such as his phone number, email, etc., then the decoded text 406 in FIG. 14 will show this information.

If the second users sends the notification, e.g., presses the virtual doorbell 408, and the first user is not immediately available, the ReachMe service running on the web-browser App can support offline message storage for later reviewing or use by the first user. For example, the ReachMe app can present the second user with a leave message option that the second user can then use to enter information for how to contact him. The Cloud server can store this information and can send the first user a message about the QR code detection event and contact information of the second user.

Assuming the owner is available and after receiving the notification, the owner and the user can chat via either a ReachMe chat service or using a FB Messenger app, which also supports video to allow the first user to positively identify the second user. Once the second user is positively identified, via chatting or through other authentication protocol, the first user can then provide follow up steps or information for the second user. In the present scheme, the first user, using the sub-system 370 of FIG. 12, can remotely open a garage door at his home for the second user to access or create and share a temporary digital eKey, using the sub-system 300 of FIG. 12, for the second user to use to activate a smart doorlock or other secured structures or objects. The eKey can be shared via the ReachMe chat tool or via the FB messenger chat app together with its secure Getsapp for Messenger tool (used to implement FB Pay services). The scheme for sharing an eKey of the present disclosure leverages the FB Getsapp for Messenger infrastructure to share a digital eKey instead of sharing money, as shown in the sub-system 300 of FIG. 12 and previously discussed with reference to FIG. 10. The usefulness of the present system and scheme is in running, at least in part, within the popular FB-messenger tool and its Getsapp for Messenger service, otherwise known as the Messenger Platform, to support an end-to-end integrated home access management platform, which can include FB-messenger notification, Messenger chat with video identification, and eKey sharing based on the similar FB pay service infrastructure.

In an exemplary application, a first user can be reached anonymously and from just about anywhere with Internet access, including when he is out of the country. If the first user has no cellular phone service or WiFi service, then he can still be contacted via the ReachMe server using the offline message storage option or the FB-messenger notification. Further, the first user can be reached even if he moves or changes his telephone number. By leveraging off of the FB messenger ID and email address login, this information can follow the first user even if he changes other things about him.

Fire departments and police departments nationwide can recommend QR codes, used as stickers or on some other more durable tangible mediums to be posted at or near front doors of homes in various communities and neighborhoods for contacting homeowners in case of emergencies. Posted QR codes can also help neighbors to contact one another when one happen to be away or on vacation. Other benefits of using QR codes on homes include allowing new neighbors to reach out to existing neighbors, for neighbors to leave messages or chat, etc.

In some examples, a camera security system can be linked with the integrated home access management system of the present disclosure. For example, when a smart mailbox is opened or when a smart doorbell is triggered, such as by a press of a bell button or triggered by a PIR, a time stamp of the event is sent to the Cloud server of the present system. The first user or homeowner can then be presented with or access a database of recorded events to allow him to go directly to the same date/time of the recorded events as recorded on the security system to review, which can eliminate valuable minutes and hours poring over non-event on the video.

Other applications of the integrated home access management system of the present disclosure with QR codes can include use with the UBER driving service, for home meal delivery service, for laundry service, for package delivery, such as Fedex or UPS, for caregiver service, for lawn service, for dog walking service, etc. Service providers or various second users can access the QR codes to contact homeowners or various first users when dropping things off, picking things up, or attempting to access enclosed spaces for services, etc., and then getting permission by the homeowners and various first users using various means discussed elsewhere herein, such as receiving eKeys.

In some examples and as previously discussed, garage door access via application program interface API is utilized to enable coding with vendor products. The coding can include at least some or all of the following functions: notify the home owner when a visitor at the door, allow chatting with a visitor for identification purposes, and allow sharing of digital keys, such as an eKey, to let the visitor access the home or other controllable structures, such as the garage, via the visitor's phone. The same scheme can be used to open other electronic lock devices, such as a front door lock, a padlock on a luggage, a lock on a bike, a secured door at a business or storage complex, or even car locks.

Although limited embodiments of the smart systems, devices, methods and their components have been specifically described and illustrated herein, many modifications and variations will be apparent to those skilled in the art. Accordingly, it is to be understood that the smart systems and devices and their components constructed according to principles of the disclosed device, system, and method may be embodied other than as specifically described herein. The disclosure is also defined in the following claims.

What is claimed is:

1. A method of using an integrated access platform to access a secured space, the method comprising:
associating a first information related to a first user to a first data medium, said first data medium being indexed with a First IndexID on a Cloud server, which contains a plurality of IndexIDs that include the First IndexID;
placing the first data medium on an exterior of a wall structure or attaching the first data medium to an object;
receiving a notification from a second user that has decoded information with a smartphone to obtain readable text from the first data medium;
communicating with the second user using at least one of video communication, audio calling, emailing, texting, and messaging; and
presenting a soft button on the smartphone of the second user for pressing or sending an electronic key to the smartphone of the second user for use to access the secured space.

2. The method of claim 1, further comprising the step wirelessly activating a smart doorlock of a door or a smart garage opener of a garage when using the electronic key.

3. The method of claim 1, wherein the first data medium comprises a QR code.

4. The method of claim 3, further comprising accessing the Cloud server by the first user to change the first information related to the first user to a second information related to the first user.

5. The method of claim 1, wherein the smartphone of the second user is paired for use with the electronic key.

6. The method of claim 5, wherein the readable text comprises at least one of a URL link, buttons, and instructions.

7. The method of claim 1, wherein the authorizing comprises using a smartphone by the first user to communicate to the Cloud server.

8. The method of claim 1, further comprising presenting options for the second user to either communicate by chatting, video communication, or audio calling.

9. The method of claim 1, wherein the soft button is a virtual doorbell.

10. The method of claim 1, further comprising receiving a notification from a third user that has decoded information with a smartphone from the first data medium to obtain readable text.

11. The method of claim 1, further comprising associating a second information related to the first user to a second data medium, said second data medium being indexed with a Second IndexID on the Cloud server, which contains both the First IndexID and the Second IndexID.

12. A method of using an integrated access platform, the method comprising:
associating a first information related to a first user to a first data medium, said first data medium being indexed with a First IndexID on a Cloud server, which contains a plurality of IndexIDs including the First IndexID;
associating a second information related to the first user to a second data medium, said second data medium being indexed with a Second IndexID on the Cloud server, which contains both the First IndexID and the Second IndexID
placing the first data medium on an exterior of a wall structure and attaching the second data medium to an object;
receiving a notification from a second user that has decoded information with a smartphone to obtain readable text from the first data medium or from the second data medium;
communicating with the second user using at least one of video communication, audio calling, emailing, texting, and messaging; and
presenting a soft button on the smartphone of the second user to press.

13. The method of claim 12, further comprising using a smartphone by the first user to change the first information related to the first user on the first data medium to a third information, the third information and the first information conveying different information.

14. The method of claim 13, wherein Cloud server is running a ReachMe web-browser app and third information is entered using the ReachMe web-browser.

15. The method of claim 12, wherein the wall structure is part of a building, a house, or a garage and the object is a luggage, a bicycle, a strap, a computer, a car, or a book.

16. A method of using an integrated access platform, the method comprising:
associating a first information related to a first user to a first data medium, said first data medium being indexed with a First IndexID on a Cloud server, which contains a plurality of IndexIDs that include the First IndexID;
placing the first data medium on an exterior of a wall structure or attaching the first data medium to an object;
receiving a notification from a second user that has decoded information with a smartphone to obtain readable text from the first data medium; and
providing options to the second user to take action after receiving the notification, said options including at least one of displaying a soft button on the smartphone of the second user to press and displaying communication options for the second user to select to communicate with the first user.

17. The method of claim 16, further comprising using a smart phone to communicate with the smartphone of the second user after receiving the notification.

18. The method of claim 16, further comprising sending a message by the Cloud server to the smartphone of the second user.

19. The method of claim 16, wherein the communication options include video, text, or audio.

20. The method of claim 16, further comprising associating a second information related to the first user to the first data medium and associating a third information related to the first user to a second data medium, said second data medium being indexed with a Second IndexID on the Cloud server.
